(19) United States
(12) Patent Application Publication
(10) Pub. No.: US 2010/0006768 A1
(43) Pub. Date: Jan. 14, 2010

(54) PROCESS FOR PRODUCING Bi12XO20 POWDER, Bi12XO20 POWDER, RADIATION PHOTO-CONDUCTOR, RADIATION DETECTOR, AND RADIATION IMAGING PANEL

(75) Inventors: Tomotake Ikada, Ashigarakami-gun (JP); Shigeru Nakamura, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/500,274

(22) Filed: Jul. 9, 2009

(30) Foreign Application Priority Data
Jul. 10, 2008 (JP) 2008-180322
Jun. 30, 2009 (JP) 2009-154843

(51) Int. Cl. G01T 1/24; C01B 33/20; C01G 23/04; C01G 29/00; G03G 5/04; B32B 15/02

(52) U.S. Cl. 250/370.09; 423/326; 423/598; 423/594.7; 430/96; 428/402

(57) ABSTRACT

A Bi₁₂XO₂₀ powder, wherein X represents at least one kind of element selected from the group consisting of Si, Ge, and Ti, is produced by a process comprising: a step (A) of preparing a solution containing the Bi element and a solution containing the X element, a step (B) of adding the two kinds of the solutions to a mother liquor having been previously fed into a reaction chamber, a mixed liquid being thereby prepared, and a step (C) of raising a temperature of the mixed liquid from the temperature, at which the addition is begun. In the step (B), the addition of the two kinds of the solutions is performed such that the substance quantities of the Bi element and the X element in the mixed liquid increase in parallel from the time at which the addition is begun.

### BACKGROUND OF THE INVENTION

1. Field of the Invention

This invention relates to a process for producing a Bi₁₂XO₂₀ powder. This invention also relates to a Bi₁₂XO₂₀ powder obtainable by the process for producing a Bi₁₂XO₂₀ powder. This invention further relates to a radiation photo-conductor obtainable by use of the Bi₁₂XO₂₀ powder, a radiation detector comprising the radiation photo-conductor, and a radiation imaging panel utilizing the radiation photo-conductor.

2. Description of the Related Art

With respect to radiation imaging operations, such as X-ray imaging operations, for medical diagnoses, and the like, solid-state radiation detectors are utilized as radiation image information recording means. Also, various radiation imaging apparatuses, in which the solid-state radiation detectors are utilized, have heretofore been proposed and used in practice. With each of the radiation imaging apparatuses described above, radiation carrying image information of an object is detected by the solid-state detector, and an image signal representing a radiation image of the object is thereby obtained.

As for the solid-state detectors to be utilized in the radiation imaging apparatuses, various types of solid-state detectors have heretofore been proposed. For example, from the view point of an electric charge forming process for converting the radiation into electric charges, the solid-state detectors may be classified into a photo conversion type (indirect conversion type) of solid-state detector and a direct conversion type of solid-state detector. With the photo conversion type of the solid-state detector, fluorescence, which has been produced by a fluorescent substance when the radiation has been irradiated to the fluorescent substance, is detected by a photo-conductor layer, and signal electric charges having thus been generated in the photo-conductor layer are accumulated at a charge accumulating section. Also, the signal electric charges having thus been accumulated at the charge accumulating section are converted into an image signal (an electric signal), and the thus obtained image signal is outputted from the solid-state detector. With the direct conversion type of the solid-state detector, signal electric charges, which have been generated in a radiation photo-conductor layer when the radiation has been irradiated to the radiation photo-conductor layer, are collected with a charge collecting electrode and accumulated at a charge accumulating section, the signal electric charges having thus been accumulated at the charge accumulating section are converted into an electric signal, and the thus obtained electric signal is outputted from the solid-state detector.

Of the solid-state detectors described above, the direct conversion type of the solid-state detector, wherein a scintillator layer for temporarily converting the radiation to the light need not be located, has the advantages in that an image having high image sharpness is obtained. Also, from the view point of an electric charge readout process for reading out the accumulated electric charges to the exterior, the solid-state detectors may be classified into an optical readout type of solid-state detector and an electric readout type of solid-state detector. With the optical readout type of the solid-state detector, reading light (a reading electromagnetic wave) is irradiated to the solid-state detector, and electric charges having been accumulated are thereby read out. With the electric readout type of the solid-state detector, the electric charges having been generated with the irradiation of the radiation are accumulated at a charge accumulating section, and the accumulated electric charges are read out through an operation, in which an electric switch, such as a thin film transistor (TFT), a charge coupled device (CCD), or a complementary metal oxide semiconductor (CMOS) sensor, is turned on and off with respect to each of pixels.

As the material for the radiation photo-conductor layer of the direct conversion type of the solid-state detector, amorphous selenium (a-Se), which has a high dark resistance and a high response speed, has heretofore primarily used and has heretofore been utilized widely for medical diagnosis apparatuses.

However, a-Se has the characteristics in that the atomic number of the element is small, and in that the density is low (4.3 g/cm³). Therefore, a-Se has the problems in that the radiation absorptivity is low and in that, even though the thickness of the film of a-Se is set at a markedly large value (e.g., a thickness of approximately 1 mm with respect to the absorption of the X-rays), a sufficient absorption quantity is not always capable of being obtained. In order for the radiation absorptivity to be enhanced, it may be considered that the thickness of the film of a-Se is set to be large even further. However, if the thickness of the film of a-Se is set to be large even further, the problems will occur in that an applied voltage becomes high in order for an electric field to be kept, in that short-circuiting is apt to occur for the high voltage, and in that it is not always possible to obtain safety. Also, a-Se is susceptible to crystallization at a temperature of at least 50° C., does not have sufficient thermal stability, and is apt to suffer from lowering of sensitivity. Therefore, a-Se is accompanied by limitation conditions at the time of storage, transportation, and use.

In view of the problems described above, in lieu of a-Se being used, it has been studied to use a radiation photo-conductive material having the characteristics such that the principal element has a high atomic number and such that the density is high, e.g., CdTe (density: 5.9 g/cm³), HgI₂ (density: 6.4 g/cm³), PbI₂ (density: 6.2 g/cm³), or PbO (density: 9.8 g/cm³). However, the above-enumerated materials have high toxicity and are chemically unstable. Therefore, the above-enumerated materials are not always capable of being regarded as the material appropriate from the view point of practicability.

Therefore, recently, as a material for the radiation photo-conductor having good chemical stability, low toxicity, and a high density, there has been studied a Bi-containing oxide that is represented by the composition formula of Bi₁₂XO₂₀, wherein X represents at least one kind of element selected from the group consisting of Ge, Si, and Ti. (Reference may be made to, for example, Japanese Unexamined Patent Publication Nos. 11(1999)-237478 and 2000-249769; a paper by S. L. Hou et al., “Transport processes of photoinduced carriers in Bi₁₂SiO₂₀”, J. Appl. Phys., Vol. 44, No. 6, pp. 2652-2658, 1973; and a paper by B. C. Grabmaier and R. Oberschmid, “Properties of Pure and Doped Bi₁₂GeO₂₀ and Bi₁₂SiO₂₀ Crystals”, phys. stat. sol. (a), Vol. 96, pp. 199-210, 1986.) In Japanese Unexamined Patent Publication No. 11(1999)-237478, it is described that a composition of Bi₁₂XO₂₀, wherein the ratio of the molar quantity of the X element to the molar quantity of Bi₁₂ is equal to 1, is appropriate for the radiation photo-conductor. (Reference may be made to paragraphs [0041] and [0042] of Japanese Unexamined Patent Publication No. 11(1999)-237478.)

Since the Bi₁₂XO₂₀ material has a high X-ray absorptivity by virtue of a high density, has low toxicity, and has good chemical stability, the Bi₁₂XO₂₀ material is appropriate as the material for the radiation photo-conductor. The Bi₁₂XO₂₀ material is used in the form of, for example, a polycrystal of Bi₁₂XO₂₀, a coating film containing a resin binder, or the like, and Bi₁₂XO₂₀ particles dispersed in the resin binder, or the like. (Reference may be made to, for example, Japanese Unexamined Patent Publication No. 2000-249769 and U.S. Patent Application Publication No. 20050214581.)

In U.S. Patent Application Publication No. 20050214581, a radiation imaging panel utilizing a polycrystal constituted of Bi₁₂XO₂₀ is disclosed. It is therein described that, in cases where the radiation photo-conductor is constituted of the polycrystal, the radiation photo-conductor having a large area is capable of being formed at a low cost, the efficiency of capturing the generated electric charges is capable of being enhanced, and the sensitivity is capable of being enhanced. Also, in Japanese Unexamined Patent Publication No. 2000-249769, a radiation imaging panel, in which a coating film containing the Bi₁₂XO₂₀ oxide is used as the radiation photo-conductor, is disclosed. It is therein described that the production cost of the radiation imaging panel is capable of being kept low.

As a process for producing the polycrystal of Bi₁₂XO₂₀, for example, it is possible to employ an aerosol deposition technique (an AD technique) comprising the steps of: causing a Bi₁₂XO₂₀ powder to fly by a carrier gas, thereby aerosolizing the Bi₁₂XO₂₀ powder, blowing the aerosolized Bi₁₂XO₂₀ powder against a support, thereby depositing the Bi₁₂XO₂₀ powder on the support, and thus forming a film of the Bi₁₂XO₂₀ powder. It is also possible to employ a press sintering technique comprising the steps of: pressing a Bi₁₂XO₂₀ powder at a high pressure by use of a pressing machine, thereby forming a molded film of the Bi₁₂XO₂₀ powder, and subjecting the thus formed film to sintering processing. It is also possible to employ a green sheet technique comprising the steps of: preparing a green sheet of a Bi₁₂XO₂₀ powder (i.e., a film containing a binder), and subjecting the thus formed green sheet to binder removing processing and powder sintering processing. Also, a coating film of Bi₁₂XO₂₀ may be prepared with processing, wherein a slurry prepared by mixing the Bi₁₂XO₂₀ powder, a binder, and a solvent together is coated to form a film. In each of the cases of the polycrystal and the coating film, the Bi₁₂XO₂₀ powder is used for the production. In order for the polycrystal or the coating film having uniform and good performance to be obtained, the Bi₁₂XO₂₀ powder should preferably be such that the powder has little variation in particle composition, uniform particle shape and uniform particle size, and such that each of the particles in the powder has a size which is not susceptible to agglomeration.

As a process for producing the Bi₁₂XO₂₀ powder, there has heretofore been known a solid phase technique, in which single oxides of the constituent elements are mixed together and fired. (Reference may be made to, for example, a paper by M. Valant and D. Suvorov, “Processing and Dielectric Properties of Sillenite Compounds Bi₁₂MO_{20-δ} (M=Si, Ge, Ti, Pb, Mn, B_{2/1}P_{2/1})”, J. Am. Ceram. Soc., Vol. 84, No. 12, pp. 2900-2904, 2001.) There has also been known a technique, in which Bi₁₂XO₂₀ single crystals are grounded. (Reference may be made to, for example, Japanese Unexamined Patent Publication No. 59 (1984)-055440.) However, the Bi₁₂XO₂₀ powder obtained with the techniques described above has the drawbacks in that the particle shape and the particle size are not uniform. Particularly, the Bi₁₂XO₂₀ powder obtained with the solid phase technique often has the drawbacks in that the variation in particle composition is large. Also, impurities originating from vessels and media (ceramic balls, pestles, and mortars) utilized for the grinding steps inevitably mix into the powder. Therefore, the problems are encountered in that a finished product having sufficiently good performance is not capable of being obtained.

Further, a process for producing the Bi₁₂XO₂₀ powder with a liquid phase technique has heretofore been known. As for the liquid phase technique, a technique for synthesizing Bi₁₂XO₂₀ is described in, for example, a paper by H. S. Horowitz et al., “SOLUTION SYNTHESIS AND CHARACTERIZATION OF SILLENITE PHASES, Bi₂₄M₂O₄₀ (M=Si, Ge, V, As, P)”, Solid State Ionics, Vols. 32/33, pp. 678-690, 1989. The technique for synthesizing Bi₁₂XO₂₀ described in the aforesaid paper comprises the steps of dissolving an element source, which is selected from the group consisting of Na₂O.xSiO₂ acting as an Si source and GeO₂ acting as a Ge source, in an alkaline aqueous solution to form a mother liquor, adding an acidic Bi solution, which contains Bi(NO₃)₃ dissolved therein, to the mother liquor in order to form a precipitate, adjusting a pH value of the reaction mixture, and setting the temperature at an appropriate temperature, whereby Bi₁₂XO₂₀ is synthesized.

Furthermore, a process for synthesizing the Bi₁₂XO₂₀ powder is described in, for example, U.S. Patent Application Publication No. 20060204423. The process described therein comprises: subjecting an alkaline solution, which contains an alkali-soluble silicon compound or an alkali-soluble germanium compound, and a solution containing a water-soluble bismuth compound to mixing processing with agitation at a temperature of at least 80° C. by use of a shearing type agitator, whereby the solutions are allowed to undergo reaction.

With the technique for synthesizing Bi₁₂XO₂₀ described in the paper by H. S. Horowitz et al., “SOLUTION SYNTHESIS AND CHARACTERIZATION OF SILLENITE PHASES, Bi₂₄M₂O₄₀ (M=Si, Ge, V, As, P)”, Solid State Ionics, Vols. 32/33, pp. 678-690, 1989, it is possible to obtain the Bi₁₂XO₂₀ powder, which has uniform particle shape and uniform particle size within an identical production lot. However, as shown in Table 1 in the paper described above, the variation among different production lots is as large as the level falling within the range of 0.9≦X/Bi₁₂≦1.2, wherein X/Bi₁₂ represents the substance quantity of the X element with respect to 12 mols of the Bi element. Therefore, it is not always possible to produce with good reproducibility the Bi₁₂XO₂₀ powder falling within the composition range exhibiting good performance for the radiation photo-conductor.

Also, with the technique for synthesizing Bi₁₂XO₂₀ described in the paper by H. S. Horowitz et al., “SOLUTION SYNTHESIS AND CHARACTERIZATION OF SILLENITE PHASES, Bi₂₄M₂O₄₀ (M=Si, Ge, V, As, P)”, Solid State Ionics, Vols. 32/33, pp. 678-690, 1989, an entire quantity of potassium silicate acting as the Si source is previously fed into a reaction chamber, and an entire quantity of bismuth nitrate acting as the Bi source is then added into the reaction chamber. In cases where the production is performed with the technique described above, the composition of the oxide obtained becomes an Si-rich composition or a Bi-rich composition. (Reference may be made to, for example, Table 1 in the aforesaid paper.) Further, though the element acting as the X source in the mixed liquid is present in large excess at the time of the beginning of the addition, the proportion of Bi with respect to Si alters little by little in accordance with the addition of the Bi source. It is thus presumed that the Bi₁₂XO₂₀ powder obtained as a result will be such that the particles derived from a precipitate at the time of the beginning of the addition and the particles derived from a precipitate at the time of the finish of the addition will vary markedly. Specifically, even though the apparent mean composition is of the Bi₁₂XO₂₀ powder falling within an appropriate composition range, the variation in composition is substantially large. Therefore, in cases where the Bi₁₂XO₂₀ powder having thus been obtained is used as the radiation photo-conductor, good performance is not obtained.

Also, with the process for synthesizing the Bi₁₂XO₂₀ powder described in, for example, U.S. Patent Application Publication No. 20060204423, it is possible to suppress the variation in composition within an identical production lot and the variation in mean composition among different production lots. However, the mean particle diameter of the Bi₁₂XO₂₀ powder is as small as the value falling within the range of 0.5 μm to 2 μm, and the powder is apt to agglomerate. If the polycrystal constituted of Bi₁₂XO₂₀ is produced by use of the Bi₁₂XO₂₀ powder having the particle diameter which is apt to agglomerate, it will not always be possible to obtain the radiation photo-conductor having high uniformity in packing density. Also, in cases where the coating film is produced by use of the Bi₁₂XO₂₀ powder, if the Bi₁₂XO₂₀ powder having the particle diameter which is apt to agglomerate is used, it will not always be possible to obtain a slurry having high uniformity, and therefore it will not always be possible to obtain the radiation photo-conductor having high uniformity in packing density. Particularly, in the cases of the coating film, if the particle diameter is small, the interface between adjacent particles and the interface between the particle and the dispersing medium will increase, and there will be the risk of the problems occurring in that conduction of generated carrier is apt to be obstructed.

### SUMMARY OF THE INVENTION

The primary object of the present invention is to provide a process for producing a Bi₁₂XO₂₀ powder, wherein a Bi₁₂XO₂₀ powder is produced such that variation in composition among different production lots and within an identical production lot is suppressed.

Another object of the present invention is to provide a process for producing a Bi₁₂XO₂₀ powder, wherein a Bi₁₂XO₂₀ powder is produced such that variation in composition among different production lots and within an identical production lot is suppressed, and preferably such that Bi₁₂XO₂₀ powder has a mean particle diameter which is not susceptible to agglomeration.

A further object of the present invention is to provide a Bi₁₂XO₂₀ powder obtainable by the process for producing a Bi₁₂XO₂₀ powder in accordance with the present invention.

A still further object of the present invention is to provide a radiation photo-conductor obtainable by use of the Bi₁₂XO₂₀ powder.

Another object of the present invention is to provide a radiation detector comprising the radiation photo-conductor.

A further object of the present invention is to provide a radiation imaging panel utilizing the radiation photo-conductor.

The present invention provides a process for producing a Bi₁₂XO₂₀ powder, wherein X represents at least one kind of element selected from the group consisting of Si, Ge, and Ti, the process comprising:

i) a step (A) of preparing a solution containing the Bi element and a solution containing the X element,

ii) a step (B) of adding the solution containing the Bi element and the solution containing the X element to a mother liquor having been previously fed into a reaction chamber, a mixed liquid being thereby prepared, and

iii) a step (C) of raising a temperature of the mixed liquid from the temperature, at which the addition of the solution containing the Bi element and the solution containing the X element to the mother liquor is begun,

the addition of the solution containing the Bi element and the solution containing the X element to the mother liquor in the step (B) being performed such that both of the substance quantity of the Bi element and the substance quantity of the X element in the mixed liquid increase in parallel from the time at which the addition of the solution containing the Bi element and the solution containing the X element to the mother liquor is begun. (The definition of X will hereinbelow be omitted.)

The term “mixing” as used herein means that both of the solution containing the Bi element and the solution containing the X element are added to the mother liquor, and the mixed liquid is thereby prepared. In such cases, it is regarded that the mixing is begun at the time at which the addition of both of the solution containing the Bi element and the solution containing the X element is begun, and that the mixing is finished at the time at which the addition of all of the solution containing the Bi element and the solution containing the X element is completed.

The term “mother liquor” as used herein means the liquid having been previously fed into the reaction chamber before the addition of the solution containing the Bi element and the solution containing the X element is begun. By the addition of the solution containing the Bi element and the solution containing the X element to the mother liquor, the mixed liquid is prepared. The mother liquor may previously contain a part of the Bi element or a part of the X element.

The term “addition being performed such that substance quantities increase in parallel” as used herein means that the addition is performed such that both of the substance quantity of the Bi element and the substance quantity of the X element in the mixed liquid during the addition and at the time of the addition completion may increase over the substance quantities of the Bi element and the X element in the mixed liquid just before the addition is begun. Therefore, for example, the solution containing the Bi element and the solution containing the X element may be added to the mother liquor, which does not contain the Bi element and the X element. In such cases, in so far as the addition is performed such that both of the substance quantity of the Bi element and the substance quantity of the X element increase, each of the substance quantities of the Bi element and the X element may fluctuate. Also, the substance quantity ratio between the Bi element and the X element in the mixed liquid may vary midway during the addition. Also, the raw material solutions may be added to the mother liquor, which contains a part of the Bi element or a part of the X element.

In such cases, both of the solution containing the Bi element and the solution containing the X element may be added continuously or may be added intermittently. However, the cases, wherein the entire quantity of only the Bi element (or the X element) is added beforehand to the mother liquor, are identical with the cases, wherein the entire quantity of the Bi element (or the X element) is contained previously in the mother liquor, and are not regarded that the substance quantity of the Bi element (or the X element) increases by the addition. Therefore, the cases, wherein the entire quantity of only the Bi element (or the X element) is added beforehand to the mother liquor, are excluded from the category of the term “addition being performed such that substance quantities increase in parallel” as used herein.

The process for producing a Bi₁₂XO₂₀ powder in accordance with the present invention should preferably be modified such that, in the step (B), the ratio between the substance quantity of the Bi element and the substance quantity of the X element, which substance quantities are added to the mother liquor, is substantially kept at a predetermined value during the stage from the time, at which the addition of the solution containing the Bi element and the solution containing the X element to the mother liquor is begun, to the time, at which the addition of the solution containing the Bi element and the solution containing the X element to the mother liquor is finished.

The term “substance quantity” as used herein means the molar quantity. Also, the term “substantially kept at a predetermined value” as used herein means that the addition is performed under the conditions such that the ratio between the substance quantity of the Bi element and the substance quantity of the X element, which substance quantities are added to the mother liquor, is kept at the predetermined value. It is herein regarded that the cases, wherein the ratio between the substance quantity of the Bi element and the substance quantity of the X element fluctuates due to only the uncontrollable factors, such as weighing errors at the time of the preparation of the raw material solutions, and variation in addition quantity within an addition accuracy of an addition device, fall under the category of the term “substantially kept at a predetermined value” as used herein.

Also, the process for producing a Bi₁₂XO₂₀ powder in accordance with the present invention should preferably be modified such that, in the step (B), the technique for feeding the solution containing the Bi element and the solution containing the X element is a double jet technique.

The term “double jet technique” as used herein means the technique, wherein a bottom end of a liquid feeding flow path for the solution containing the Bi element and the bottom end of the liquid feeding flow path for the solution containing the X element are located in the mother liquor, wherein the solution containing the Bi element and the solution containing the X element are directly added to the mother liquor, and wherein the mixed liquid is thereby prepared.

Further, the process for producing a Bi₁₂XO₂₀ powder in accordance with the present invention should preferably be modified such that, in the step (B), the preparation of the mixed liquid is performed such that the temperature of the mixed liquid falls within the range of a temperature higher than 25° C. to a temperature lower than 75° C. Furthermore, the process for producing a Bi₁₂XO₂₀ powder in accordance with the present invention should preferably be modified such that, in the step (C), the temperature of the mixed liquid is raised up to a temperature falling within the range of a temperature higher than 65° C. to a temperature lower than 100° C.

Also, the process for producing a Bi₁₂XO₂₀ powder in accordance with the present invention should preferably be modified such that a pH value of the mixed liquid is set to be equal to at most 13.5. Alternatively, the process for producing a Bi₁₂XO₂₀ powder in accordance with the present invention should preferably be modified such that a pH value of the mixed liquid is set to be equal to at least 14.

The present invention also provides a Bi₁₂XO₂₀ powder obtainable by the process for producing a Bi₁₂XO₂₀ powder in accordance with the present invention, the Bi₁₂XO₂₀ powder having a mean particle diameter falling within the range of a value larger than 2 μm to a value smaller than 20 μm, the Bi₁₂XO₂₀ powder having a composition satisfying the condition of Formula (1) shown below. The Bi₁₂XO₂₀ powder should preferably have a composition satisfying the condition of Formula (2) shown below.

0.91≦X/Bi₁₂≦1.09 (1)

0.94≦X/Bi₁₂≦0.99 (2)

In Formulas (1) and (2), X/Bi₁₂ represents the substance quantity of the X element with respect to 12 mols of the Bi element. (The definition of X/Bi₁₂ will hereinbelow be omitted.)

The present invention further provides a first radiation photo-conductor, obtainable by use of the Bi₁₂XO₂₀ powder in accordance with the present invention.

The present invention still further provides a second radiation photo-conductor, containing a Bi₁₂XO₂₀ polycrystal, with the proviso that the radiation photo-conductor may contain inevitable impurities,

wherein the polycrystal has a composition satisfying the condition of Formula (2) shown above. The present invention also provides a third radiation photo-conductor, containing a binder and a Bi₁₂XO₂₀ powder, the particles of which have been bound with one another by the binder, wherein the Bi₁₂XO₂₀ powder has a composition satisfying the condition of Formula (2) shown above.

The present invention further provides a radiation detector, comprising:

i) the radiation photo-conductor in accordance with the present invention, and

ii) electrodes for applying an electric field across the radiation photo-conductor.

The present invention still further provides a first radiation imaging panel, wherein carriers having been generated in a radiation photo-conductor layer by irradiation of radiation to the radiation photo-conductor layer are read out as electric charges by application of an electric field across the radiation photo-conductor layer, the radiation imaging panel comprising:

i) the radiation photo-conductor layer containing the radiation photo-conductor in accordance with the present invention,

ii) a pair of electrodes for applying the electric field across the radiation photo-conductor layer, and

iii) electric current detecting means for detecting the carriers having been generated in the radiation photo-conductor layer.

The present invention also provides a second radiation imaging panel, wherein carriers having been generated in a radiation photo-conductor layer by irradiation of radiation to the radiation photo-conductor layer are accumulated as electric charges, wherein an electrostatic latent image is thereby formed, and wherein the electric charges are read out by irradiation of light, the radiation imaging panel comprising:

i) a first electrode for applying an electric field across the radiation photo-conductor layer,

ii) the radiation photo-conductor layer containing the radiation photo-conductor in accordance with the present invention,

iii) a charge transporting layer for accumulating the carriers as the electric charges,

iv) a reading photo-conductor layer for taking out the electric charges, which have been accumulated at the charge transporting layer, by the irradiation of the light,

v) a second electrode for applying the electric field across the radiation photo-conductor layer, and

vi) electric current detecting means for detecting the electric charges having been taken out into the reading photo-conductor layer,

the first electrode, the radiation photo-conductor layer, the charge transporting layer, the reading photo-conductor layer, the second electrode, and the electric current detecting means being located successively.

The process for producing a Bi₁₂XO₂₀ powder in accordance with the present invention is characterized by adding the solution containing the Bi element and the solution containing the X element to the mother liquor such that both of the substance quantity of the Bi element and the substance quantity of the X element in the mixed liquid increase in parallel, thereby preparing the mixed liquid, and then raising the temperature of the mixed liquid from the temperature, at which the addition of the solution containing the Bi element and the solution containing the X element to the mother liquor is begun. Since the raw material solutions are added to the mother liquor such that both of the substance quantity of the Bi element and the substance quantity of the X element in the mixed liquid increase in parallel, the ratio between the contents of the Bi element and the X element in the reaction chamber does not deviate markedly from the composition of Bi₁₂XO₂₀, and the reaction is allowed to proceed in such a state. Also, after the reaction has been allowed to begun at the comparatively low temperature, the reaction temperature is raised, and crystallization is caused to occur. Therefore, the number of the formed nuclei is kept to be sufficiently small, and the particle sizes are kept large. Accordingly, with the process for producing a Bi₁₂XO₂₀ powder in accordance with the present invention, the Bi₁₂XO₂₀ powder having a mean particle diameter which is not susceptible to agglomeration is produced such that variation in composition among production lots and within an identical production lot is suppressed.

The present invention will hereinbelow be described in further detail with reference to the accompanying drawings.

### BRIEF DESCRIPTION OF THE DRAWINGS

FIG. 1 is a schematic view showing an example of a production apparatus, which may be used for carrying out an embodiment of the production process in accordance with the present invention,

FIG. 2 is a schematic view showing a different example of a production apparatus, which may be used for carrying out an embodiment of the production process in accordance with the present invention,

FIG. 3 is a schematic view showing a further different example of a production apparatus, which may be used for carrying out an embodiment of the production process in accordance with the present invention,

FIG. 4 is a schematic view showing a still further different example of a production apparatus, which may be used for carrying out an embodiment of the production process in accordance with the present invention,

FIG. 5 is a schematic sectional view showing an embodiment of a radiation detector comprising a radiation photo-conductor obtained by use of the Bi₁₂XO₂₀ powder in accordance with the present invention,

FIG. 6 is a schematic view showing a film forming apparatus for performing an AD technique, which apparatus may be used for the production of a radiation photo-conductor in accordance with the present invention,

FIG. 7 is an explanatory view showing a radiation detecting section and an AMA board, which are combined together,

FIG. 8 is a schematic sectional view showing regions of the radiation detecting section and the AMA board, which regions correspond to one pixel,

FIG. 9 is an electric circuit diagram showing an equivalent circuit of the AMA board,

FIG. 10 is a schematic sectional view showing an embodiment of a radiation imaging panel, which comprises a radiation photo-conductor in accordance with the present invention,

FIG. 11 is a schematic view showing a recording and readout system, in which the radiation imaging panel of FIG. 10 is employed,

FIGS. 12A to 12D are explanatory views showing electric charge models for explanation of an electrostatic latent image recording stage in the recording and readout system of FIG. 11,

FIGS. 13A to 13D are explanatory views showing electric charge models for explanation of an electrostatic latent image readout stage in the recording and readout system of FIG. 11,

FIG. 14 is a graph showing relationship between substance quantities of the Bi element and the Si element in a mixed liquid in Example 1,

FIG. 15 is a graph showing an X-ray diffraction pattern of Bi₁₂XO₂₀ powder produced in Example 1,

FIG. 16 is a graph showing a particle size distribution of the Bi₁₂XO₂₀ powder produced in Example 1,

FIG. 17 is a graph showing an X-ray diffraction pattern of the Bi₁₂XO₂₀ powder produced in each of Examples 1 and 3,

FIG. 18 is a graph showing relationship between substance quantities of the Bi element and the Si element in a mixed liquid in Example 10,

FIG. 19 is a graph showing relationship between substance quantities of the Bi element and the Si element in a mixed liquid in Example 11,

FIG. 20 is a graph showing relationship between an added element quantity ratio and a powder composition ratio,

FIG. 21 is a graph showing a particle size distribution of Bi₁₂XO₂₀ powder produced in Comparative Example 4,

FIG. 22 is a schematic sectional view showing a compression apparatus used for preparation of a detecting section of a radiation imaging panel, and

FIG. 23 is a graph showing results of evaluation of radiation photoelectric characteristics.

### DETAILED DESCRIPTION OF THE INVENTION

### Process for Producing a Bi₁₂XO₂₀ Powder

The process for producing a Bi₁₂XO₂₀ powder in accordance with the present invention comprises:

i) the step (A) of preparing the solution containing the Bi element and the solution containing the X element,

ii) the step (B) of adding the solution containing the Bi element and the solution containing the X element to the mother liquor having been previously fed into the reaction chamber, the mixed liquid being thereby prepared, and

iii) the step (C) of raising the temperature of the mixed liquid from the temperature, at which the addition of the solution containing the Bi element and the solution containing the X element to the mother liquor is begun,

the addition of the solution containing the Bi element and the solution containing the X element to the mother liquor in the step (B) being performed such that both of the substance quantity of the Bi element and the substance quantity of the X element in the mixed liquid increase in parallel from the time at which the addition of the solution containing the Bi element and the solution containing the X element to the mother liquor is begun.

Each of the steps will be described hereinbelow. The step (A) is the step of preparing the solution containing the Bi element and the solution containing the X element. In the present invention, the solution containing the Bi element as the principal constituent and/or the solution containing the X element as the principal constituent may also contain other added elements, impurities, and the like.

In the step (A), the solution containing the Bi element may be prepared by dissolving a Bi-containing compound, which acts as a Bi source, in a solvent. Examples of the Bi sources, which may be employed in the present invention, include compounds, such as bismuth nitrate, bismuth carbonate, bismuth acetate, bismuth phosphate, bismuth trifluoride, bismuth trichloride, bismuth tribromide, bismuth triiodide, bismuth hydroxide, bismuth oxycarbonate, bismuth oxychloride, tri-1-propoxybismuth (Bi(O-i-C₃H₇)₃), triethoxybismuth (Bi(OC₂H₅)₃), tri-t-amyloxybismuth (Bi(O-t-C₅H₁₁)₃), triphenylbismuth (Bi(C₆H₅)₃), tris(dipivaloylmethanato)bismuth (Bi(C₁₁H₁₉O₂)₃), and bismuth oxide. From the view point of a low cost, the Bi source should preferably be bismuth nitrate, bismuth carbonate, bismuth acetate, bismuth phosphate, bismuth trifluoride, bismuth trichloride, bismuth tribromide, bismuth triiodide, bismuth hydroxide, bismuth oxycarbonate, bismuth oxychloride, or bismuth oxide. From the view point of little fluctuation in Bi content, the Bi source should more preferably be bismuth oxide.

In the step (A), as in the cases of the Bi element, the solution containing the X element may be prepared by dissolving an X element-containing compound, which acts as an X source, in a solvent. In cases where the X element is Si, examples of the Si sources, which may be employed in the present invention, include compounds, such as silicon tetrachloride, silicon tetrabromide, silicon tetraiodide, silicon acetate, silicon oxalate, sodium orthosilicate, potassium orthosilicate, sodium metasilicate, potassium metasilicate, sodium silicate, potassium silicate, calcium silicate, sodium disilicate, potassium disilicate, hexafluorosilicic acid, ammonium hexafluorosilicate, sodium hexafluorosilicate, potassium hexafluorosilicate, silicon monoxide, silicon dioxide (crystalline), silicon dioxide (amorphous), colloidal silica, tetramethoxysilane (Si(OCH₃)₄), tetraethoxysilane (Si(OC₂H₅)₄), tetra-i-propoxysilane (Si(O-i-C₃H₇)₄), tetra-n-propoxysilane (Si(O-n-C₃H₇)₄), tetra-i-butoxysilane (Si(O-i-C₄H₉)₄), tetra-n-butoxysilane (Si(O-n-C₄H₉)₄), tetra-sec-butoxysilane (Si(O-sec-C₄H₉)₄), tetra-t-butoxysilane (Si(O-t-C₄H₉)₄), SiH[N(CH₃)₂]₃, and SiH[N(C₂H₅)₂]₃.

Also, in cases where the X element is Ge, examples of the Ge sources, which may be employed in the present invention, include compounds, such as germanium tetrachloride, germanium tetrabromide, germanium tetraiodide, germanium acetate, germanium oxalate, sodium orthogermanate, potassium orthogermanate, sodium metagermanate, potassium metagermanate, sodium germanate, potassium germanate, calcium germanate, sodium digermanate, potassium digermanate, hexafluorogermanic acid, ammonium hexafluorogermanate, sodium hexafluorogermanate, potassium hexafluorogermanate, germanium dioxide, tetramethoxygermanium (Ge(OCH₃)₄), tetraethoxygermanium (Ge(OC₂H₅)₄), tetra-i-propoxygermanium (Ge(O-i-C₃H₇)₄), tetra-n-propoxygermanium (Ge(O-n-C₃H₇)₄), tetra-i-butoxygermanium (Ge(O-i-C₄H₉)₄), tetra-n-butoxygermanium (Ge(O-n-C₄H₉)₄), tetra-sec-butoxygermanium (Ge(O-sec-C₄H₉)₄), and tetra-t-butoxygermanium (Ge(O-t-C₄H₉)₄).

Further, in cases where the X element is Ti, examples of the Ti sources, which may be employed in the present invention, include compounds, such as titanium tetrachloride, titanium tetrabromide, titanium tetraiodide, titanium acetate, titanium oxalate, sodium titanate, potassium titanate, calcium titanate, hexafluorotitanic acid, ammonium hexafluorotitanate, sodium hexafluorotitanate, potassium hexafluorotitanate, titanium dioxide, tetramethoxytitanium (Ti(OCH₃)₄), tetraethoxytitanium (Ti(OC₂H₅)₄), tetra-i-propoxytitanium (Ti(O-i-C₃H₇)₄), tetra-n-propoxytitanium (Ti(O-n-C₃H₇)₄), tetra-i-butoxytitanium (Ti(O-i-C₄H₉)₄), tetra-n-butoxytitanium (Ti(O-n-C₄H₉)₄), tetra-sec-butoxytitanium (Ti(O-sec-C₄H₉)₄), tetra-t-butoxytitanium (Ti(O-t-C₄H₉)₄), Ti[N(CH₃)₂]₄, and Ti[N(C₂H₅)₂]₄.

As the solvent for dissolving the Bi source and the X source described above, water or an organic solvent, such as an alcohol, should preferably be used. From the view point of the low cost, water should more preferably be used. Also, since the Bi element is scarcely dissolved in water in an alkaline region, the obtained solution should preferably be acidic. In cases where an acid is used for rendering the solution acidic, one of a wide variety of acids may be used. For example, it is possible to use an inorganic acid, such as hydrochloric acid, sulfuric acid, nitric acid, phosphoric acid, boric acid, or hydrofluoric acid; or an organic acid, such as formic acid, acetic acid, oxalic acid, or citric acid.

In the production process in accordance with the present invention, such that Bi₁₂XO₂₀ may be obtained ultimately as a precipitate, the mixed liquid should preferably be in the alkaline state in which the solubility of Bi is low. Therefore, the solution in which the X source has been dissolved should preferably be alkaline. In cases where an alkaline compound is used in order for the solution to be rendered alkaline, one of a wide variety of alkaline compounds may be used. For example, it is possible to use a compound, such as LiOH, KOH, NaOH, RbOH, ammonia, or NR₄OH, wherein R represents an alkyl group.

Examples of the step (B) and the step (C) will be described hereinbelow with reference to the accompanying drawings.

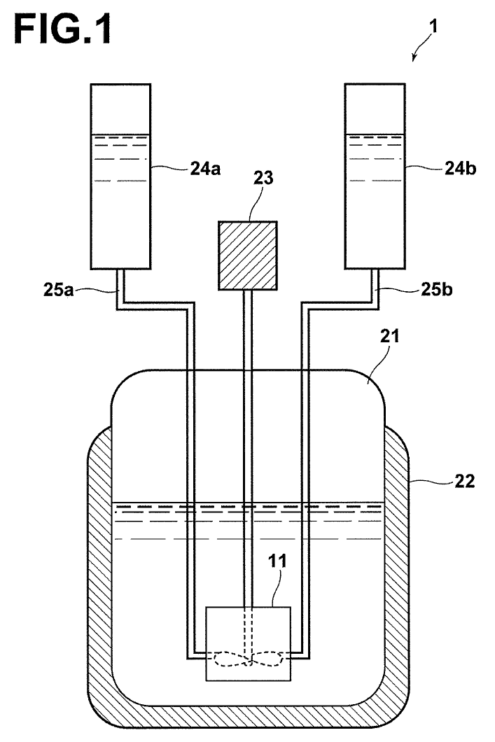

Each of FIG. 1 to FIG. 4 is a schematic sectional view showing a reaction apparatus 1, 2, 3 or 4, which may be used for carrying out an embodiment of the process for producing a Bi₁₂XO₂₀ powder in accordance with the present invention. As illustrated in each of FIG. 1 to FIG. 4, the reaction apparatus 1, 2, 3 or 4 comprises a reaction chamber 21 for heating and agitating the mixed liquid and thereby allowing the reaction to occur. The reaction apparatus 1, 2, 3 or 4 also comprises a temperature control section 22 for heating the reaction chamber 21. The reaction apparatus 1, 2, 3 or 4 further comprises a motor 23 and an agitating section 11, 12, or 14 for agitating the reaction mixture. The reaction apparatus 1, 2, 3 or 4 still further comprises a solution tank 24a for loading the solution containing the Bi element, and a liquid feeding flow path 25a for feeding the solution containing the Bi element into the reaction chamber 21. The reaction apparatus 1, 2, 3 or 4 also comprises a solution tank 24b for loading the solution containing the X element, and a liquid feeding flow path 25b for feeding the solution containing the X element into the reaction chamber 21. The reaction apparatuses 1, 2, 3 and 4 are constituted basically in the same manner, except for the constitutions of the agitating sections 11, 12, and 14, the constitutions of the liquid feeding flow paths 25a and 25b, and the like.

Firstly, the reaction apparatus 1, 2, 3 or 4 is prepared. Thereafter, the solution containing the Bi element and the solution containing the X element having been prepared in the step (A) are loaded respectively into the solution tanks 24a and 24b. Also, the mother liquor is loaded into the reaction chamber 21 in a quantity of at least a level such that the agitating section 11, 12, or 14 may be immersed in the mother liquor. In such cases, the mother liquor may not contain the Bi element and the X element. Alternatively, when necessary, the mother liquor may contain a part of the total feeding quantity of the Bi element or the X element. As the mother liquor, water or an organic solvent, such as an alcohol, may be used. From the view point of the low cost, water should preferably be used. In the production process in accordance with the present invention, such that Bi₁₂XO₂₀ may be obtained ultimately as the precipitate, the mixed liquid should preferably be in the alkaline state in which the solubility of Bi is low. Therefore, the mother liquor should preferably be alkaline. In cases where an alkaline compound is used in order for the mother liquor to be rendered alkaline, one of a wide variety of alkaline compounds may be used. For example, it is possible to use a compound, such as LiOH, KOH, NaOH, RbOH, ammonia, or NR₄OH, wherein R represents an alkyl group.

The pH value of the mixed liquid should preferably be equal to at most 13.5, or should preferably be equal to at least 14. The adjustment of the pH value of the mixed liquid may be made by adjusting the pH value of the solution in which the X source has been dissolved, the solution in which the Bi source has been dissolved, and the mother liquor. In cases where the pH value of the mixed liquid is adjusted to be equal to at most 13.5, specifically in cases where the pH value of the mixed liquid is adjusted so as to fall within the range of 10 to 13.5, the loading composition and the particle composition alter linearly, and the particles having the desired composition are obtained. (If the pH value of the mixed liquid is lower than 10, it will become difficult to obtain the Bi₁₂XO₂₀ powder.) In cases where the pH value of the mixed liquid is adjusted to be equal to at least 14, though there will be the risk that it will become not easy to prepare the particles having the desired composition, the advantages are obtained in that little influence of the loading composition occurs, and in that little fluctuation occurs with the composition of the obtained Bi₁₂XO₂₀ powder. Therefore, composition control is made easily by the appropriate adjustment of the pH value, and the Bi₁₂XO₂₀ powder adapted to the use applications is thus obtained.

The temperature control section 22 is then actuated, and the temperature of the mother liquor contained in the reaction chamber 21 is set at a desired value. Since the temperature of the mixed liquid to be prepared should preferably fall within the range of a temperature higher than 25° C. to a temperature lower than 75° C. (for the reason which will be described later), the temperature of the mother liquor should preferably fall within the range of a temperature higher than 25° C. to a temperature lower than 75° C.

Thereafter, in the step (B), the solution containing the Bi element and the solution containing the X element are added into the reaction chamber 21. At this time, such that the temperature within the reaction chamber 21 may not change due to the addition of the raw material solutions, the solution tanks 24a, 24b and the liquid feeding flow paths 25a, 25b should preferably be set at a desired temperature. However, in cases where the temperature control section 22 has a heat capacity sufficiently large with respect to the quantities of the raw material solutions added, and the change of the temperature within the reaction chamber 21 due to the addition of the raw material solutions is small such that the change of the temperature within the reaction chamber 21 may not adversely affect the particle forming reaction, the control of the temperatures of the solution tanks 24a, 24b and the liquid feeding flow paths 25a, 25b need not necessarily be performed.

In the step (B), the addition of the solution containing the Bi element and the solution containing the X element into the reaction chamber 21 is performed such that both of the substance quantity of the Bi element and the substance quantity of the X element in the mixed liquid increase in parallel from the time at which the addition of the solution containing the Bi element and the solution containing the X element into the reaction chamber 21 is begun. It is presumed that the variation in composition among different production lots and within an identical production lot will be caused to occur in cases where Bi element deficiency or X element deficiency occurs in a crystal lattice, or in cases where the X element becomes apt to enter into a position other than a predetermined site in the crystal lattice when, for example, X element-rich condition arises in the reaction chamber.

Accordingly, in cases where the addition is performed such that the ratio between the contents of the Bi element and the X element in the reaction chamber 21 does not deviate markedly from the composition of Bi₁₂XO₂₀, i.e., such that both of the substance quantity of the Bi element and the substance quantity of the X element in the mixed liquid increase in parallel from the time at which the addition of the solution containing the Bi element and the solution containing the X element into the reaction chamber 21 is begun, the variation in composition among different production lots and within an identical production lot is suppressed.

In the step (B), the addition of the solution containing the Bi element and the solution containing the X element into the reaction chamber 21 may be performed in one of a wide variety of manners in so far as the addition is performed such that both of the substance quantity of the Bi element and the substance quantity of the X element in the mixed liquid increase in parallel from the time at which the addition of the solution containing the Bi element and the solution containing the X element into the reaction chamber 21 is begun. However, the addition should not be performed such that one kind of the element is added into the reaction chamber, into which the entire quantity of the other kind of the element has been fed previously, as described in, for example, the paper by H. S. Horowitz et al., “SOLUTION SYNTHESIS AND CHARACTERIZATION OF SILLENITE PHASES, Bi₂₄M₂O₄₀ (M=Si, Ge, V, As, P)”, Solid State Ionics, Vols. 32/33, pp. 678-690, 1989. For example, in cases where part of the quantity of either one of the Bi element and the X element is fed previously into the reaction chamber, and the addition into the reaction chamber is performed such that both of the substance quantity of the Bi element and the substance quantity of the X element in the mixed liquid increase in parallel from the time at which the addition of the solution containing the Bi element and the solution containing the X element into the reaction chamber 21 is begun, the effect of suppressing the deviation in composition is obtained.

In order for the deviation in composition to be suppressed more effectively, the ratio between the substance quantity of the Bi element and the substance quantity of the X element, which substance quantities are added to the mother liquor, should preferably be substantially kept at a predetermined value during the stage from the time, at which the addition of the solution containing the Bi element and the solution containing the X element to the mother liquor is begun, to the time, at which the addition of the solution containing the Bi element and the solution containing the X element to the mother liquor is finished. For example, throughout the stage from the time, at which the addition of the solution containing the Bi element and the solution containing the X element to the mother liquor is begun, to the time, at which the addition of the solution containing the Bi element and the solution containing the X element to the mother liquor is finished, both of the Bi element and the X element should preferably be added, such that the ratio between the substance quantity of the Bi element and the substance quantity of the X element, which substance quantities are added to the mother liquor, may be kept at a predetermined ratio in the vicinity of 12:1, i.e., such that the condition of Formula (1) shown below may be satisfied in the mixed liquid. Throughout the stage described above, both of the Bi element and the X element should more preferably be added, such that the condition of Formula (2) shown below may be satisfied in the mixed liquid. In such cases, at the stage before the addition is begun, the mother liquor may contain a part of the Bi element or the X element besides the quantity to be added. However, it is preferable that, at the stage before the addition is begun, the mother liquor does not contain a part of the Bi element or the X element. In cases where the addition is performed in the manner described above, the chemical reaction is allowed to proceed uniformly throughout the stage from the time, at which the addition of the solution containing the Bi element and the solution containing the X element to the mother liquor is begun, to the time, at which the addition of the solution containing the Bi element and the solution containing the X element to the mother liquor is finished. Therefore, variation of the composition of the Bi₁₂XO₂₀ powder is suppressed effectively.

0.91≦X/Bi₁₂≦1.09 (1)

0.94≦X/Bi₁₂≦0.99 (2)

Also, the ratio between the substance quantity of the Bi element and the substance quantity of the X element in the mixed liquid at the time, at which the addition of the raw material solutions is finished, should preferably be identical with the ratio between the substance quantity of the Bi element and the substance quantity of the X element in the Bi₁₂XO₂₀ powder to be prepared. Specifically, in the mixed liquid, the condition of 0.91≦X/Bi₁₂≦1.09 should preferably be satisfied, and the condition of 0.94≦X/Bi₁₂≦0.99 should more preferably be satisfied.

As described above, in cases where both of the Bi element and the X element are added in the step (B) such that the condition of Formula (1) shown above may be satisfied in the mixed liquid, the composition of the Bi₁₂XO₂₀ powder is set so as to satisfy the condition of Formula (1) shown above regardless of the production lots. Also, in cases where both of the Bi element and the X element are added in the step (B) such that the condition of Formula (2) shown above may be satisfied in the mixed liquid, the composition of the Bi₁₂XO₂₀ powder is set so as to satisfy the condition of Formula (2) shown above regardless of the production lots.

Further, in the step (B), the preparation of the mixed liquid should preferably be performed such that the temperature of the mixed liquid falls within the range of a temperature higher than 25° C. to a temperature lower than 75° C. In cases where the preparation of the mixed liquid is performed within the temperature range described above, the Bi₁₂XO₂₀ powder is obtained by the reaction for several hours. If the preparation of the mixed liquid is performed under conditions other than the temperature range described above, a longer reaction time will be required before Bi₁₂XO₂₀ is obtained. The formation of the Bi₁₂XO₂₀ particles already proceeds immediately after the mixing is begun, depending upon the temperature of the mixed liquid.

In the subsequent step (C), the temperature of the mixed liquid is raised from the temperature, at which the addition of the solution containing the Bi element and the solution containing the X element to the mother liquor is begun. The raising of the temperature of the mixed liquid may be begun immediately after the addition is begun. Alternatively, the raising of the temperature of the mixed liquid may be begun midway during the addition or after the addition is finished. However, such that the chemical condition of the precipitate, which is formed immediately after the addition is begun, may be kept uniform, the temperature control should preferably be performed such that the temperature is kept at a predetermined value until the addition is finished, and such that the raising of the temperature is begun after the addition is finished. For example, in the step (C), the raising of the temperature may be begun from the temperature of the mixed liquid (which falls within the aforesaid range of a temperature higher than 25° C. to a temperature lower than 75° C.) and may be ceased at the temperature falling within the range of a temperature higher than 65° C. to a temperature lower than 100° C. In cases where the reaction is thus allowed to begun at the comparatively low temperature, the number of the formed nuclei is kept to be sufficiently small. The reaction temperature is then raised, and crystallization is thus caused to occur sufficiently. Therefore, the Bi₁₂XO₂₀ powder having the particle sizes falling within the range of a value larger than 2 μm to a value smaller than 20 μm is obtained.

In cases where the raising of the temperature is performed within the temperature range described above, the Bi₁₂XO₂₀ powder is obtained by the reaction for several hours. If the raising of the temperature of the mixed liquid is performed under conditions other than the temperature range described above, a longer reaction time will be required before the Bi₁₂XO₂₀ powder is obtained. Also, if the raising of the temperature is performed up to a temperature of at least 100° C., the problems will occur in that, in cases where an aqueous type reaction solvent is used, it becomes necessary to use a pressure resistant chamber, and therefore the cost becomes high. The reaction, with which the Bi₁₂XO₂₀ particles are formed, proceeds before the temperature is raised, depending upon the temperature of the mixed liquid.

In the step (B) and the step (C), the agitation of the mixed liquid need not necessarily be performed. However, the agitation of the mixed liquid should preferably be performed for the purposes of promotion of the mixing, promotion of the reaction, uniformity of the reaction mixture by circulation, and the like. In cases where the agitation is performed, one of a wide variety of agitation techniques may be employed, and no limitation is particularly imposed upon the constitution of the agitating section 11. For example, the agitation may be performed by rotating an agitating blade by use of a motor. Alternatively, the agitation may be performed by rotating a magnetic rotor by use of a magnetic stirrer. As another alternative, the agitation may be performed by use of a shearing type agitator.

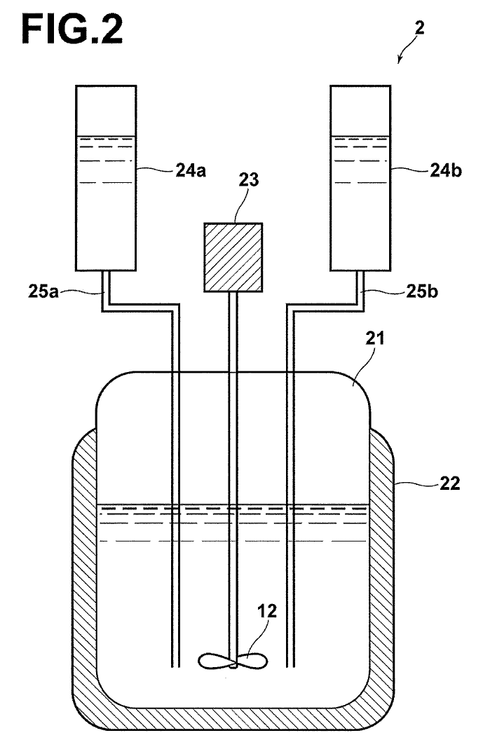

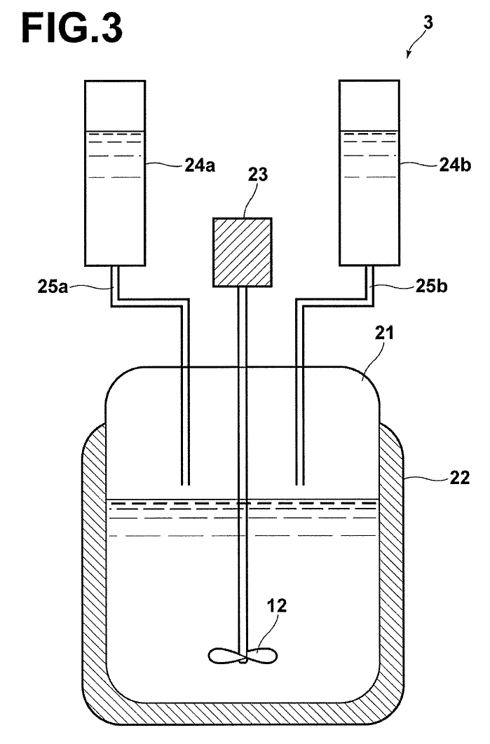

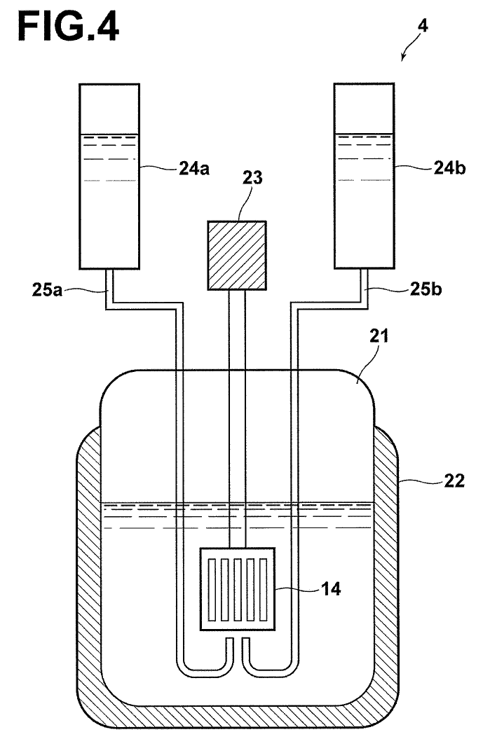

Also, in lieu of the agitation being performed, the entire reaction chamber 21 or the entire reaction apparatus may be shaken and rotated. Each of the production apparatuses illustrated in FIG. 1, FIG. 2, and FIG. 3 employs the agitation technique utilizing the agitating blade. The production apparatus illustrated in FIG. 4 employs the agitation technique utilizing the shearing type agitator.

As the shape of the agitating blade, it is possible to employ a propeller type, a fan type, a U-shaped type, a cross type, a dragonfly type, a butterfly type, an anchor type, a turbine type, a woodruff type, a kneader type, a centrifugal force type, a dissolution type, or the like. As the magnetic rotor, it is possible to employ a pivot type, an octagon type, a triangular prism type, a flat oval type, a star type, a cross notch type, a football type, a barbell type, a gear type, a cross type, a wheel type, a doughnut type, or the like. As the shearing type agitator, a homogenizer, or the like, may be used. For example, Omni Mixer (trade name, supplied by Yamato Scientific Co., Ltd.) may be used.

In cases where the agitation is performed, no limitation is imposed upon the agitation speed. However, in order for the agitation and fixing efficiency to be enhanced, the agitation speed should preferably be equal to at least 500 rpm.

As a technique for adding the solution containing the Bi element and the solution containing the X element to the mother liquor, the bottom ends of the liquid feeding flow paths 25a and 25b may be set at positions above the mother liquor, and the raw material solutions may be added from above the mother liquor (a top surface addition technique, illustrated in FIG. 3). Alternatively, the bottom ends of the liquid feeding flow paths 25a and 25b may be set at positions within the mother liquor, and the raw material solutions may be added to the positions within the mother liquor (the double jet technique, illustrated in FIG. 1, FIG. 2, and FIG. 4). In order for uniform mixing to be performed, the double jet technique should preferably be employed. In the cases of the double jet technique, the bottom ends of the liquid feeding flow paths 25a and 25b should preferably be set at positions in the vicinity of the agitating section 11, 12, or 14, which is provided with the agitating blade, the magnetic rotor, or a generator of the shearing type agitator, such that the raw material solutions having been added may be immediately mixed uniformly. In the cases of the double jet technique, in order for the uniform mixing to be enhanced, as illustrated in FIG. 1, a screen should preferably be located in the vicinity of the agitating section. Also, such that the mixing efficiency may be enhanced, the bottom ends of the liquid feeding flow paths 25a and 25b should more preferably be set at positions in the immediate vicinity of the agitating section and within the region surrounded by the screen. The addition with the double jet technique is advantageous in that the Bi element and the X element are quickly allowed to react with each other in the mixed liquid.

After the steps (A), (B), and (C) described above have been performed, removal of the liquid constituent and washing are performed, drying is performed finally, and the desired Bi₁₂XO₂₀ powder is thereby obtained. The removal of the liquid constituent may be performed by use of a filtration technique at atmospheric pressure or at reduced pressure, a centrifugal technique, or the like. The washing may be performed by use of water, hot water, an alcohol, or the like. The drying may be performed by use of a heating technique, a pressure reducing technique, an air-drying technique, or the like.

As described above, with the process for producing a Bi₁₂XO₂₀ powder in accordance with the present invention, the raw material solutions are added to the mother liquor such that both of the substance quantity of the Bi element and the substance quantity of the X element in the mixed liquid increase in parallel. Therefore, the ratio between the contents of the Bi element and the X element in the reaction chamber does not deviate markedly from the composition of Bi₁₂XO₂₀, and the reaction is allowed to proceed in such a state. Also, after the reaction has been allowed to begun at the comparatively low temperature, the reaction temperature is raised, and crystallization is caused to occur. Therefore, the number of the formed nuclei is kept to be sufficiently small, and the particle sizes are kept large. Accordingly, with the process for producing a Bi₁₂XO₂₀ powder in accordance with the present invention, the Bi₁₂XO₂₀ powder having a mean particle diameter which is not susceptible to agglomeration is produced such that variation in composition among production lots and within an identical production lot is suppressed.

### [Bi₁₂XO₂₀ Powder]

The Bi₁₂XO₂₀ powder obtainable by the process for producing a Bi₁₂XO₂₀ powder in accordance with the present invention has the mean particle diameter falling within the range of a value larger than 2 μm to a value smaller than 20 μm and has the composition satisfying the condition of Formula (1) or Formula (2) shown below.

0.91≦X/Bi₁₂≦1.09 (1)

0.94≦X/Bi₁₂≦0.99 (2)

In lieu of the reaction temperature being kept at a predetermined value as in U.S. Patent Application Publication No. 20060204423, the reaction is allowed to begun at the comparatively low temperature. Therefore, the number of the formed nuclei is kept to be sufficiently small. The reaction temperature is then raised, and crystallization is thus caused to occur sufficiently. Therefore, the Bi₁₂XO₂₀ powder having the particle sizes falling within the range of a value larger than 2 μm to a value smaller than 20 μm is obtained. In order for the agglomeration to be suppressed, the mean particle diameter should preferably be equal to at least 2 μm, and should more preferably be equal to at least 3 μm.

Also, in cases where the coating liquid, which contains a binder, or the like, and a powder dispersed in the binder, or the like, is employed as in the cases of the production of the polycrystal film with the green sheet technique or the production of the coating film, the mean particle size should preferably be such that the Bi₁₂XO₂₀ particles are not apt to agglomerate in the coating liquid and are not apt to sediment in the coating liquid. Such that the Bi₁₂XO₂₀ powder may not be apt to sediment in the coating liquid, the mean particle diameter of the Bi₁₂XO₂₀ powder should preferably be equal to at most 20 μm, and should more preferably be equal to at most 10 μm, depending upon the density of the Bi₁₂XO₂₀ particles, the density of the binder for dispersing the Bi₁₂XO₂₀ particles, or the like.

In the present invention, evaluation of the obtained Bi₁₂XO₂₀ powder is performed with the technique described below.

Specifically, identification of the crystal phase is performed by use of a powder X-ray diffraction technique. For example, the crystal phase may be identified with a technique, wherein a profile having been obtained by making θ/2θ measurements by use of an X-ray diffraction apparatus (Ultima III, supplied by Rigaku Corporation) is compared with a profile of the Bi₂XO₂₀ compound in an ICDD (International Centre for Diffraction Data) card.

The evaluation of the mean particle diameter may be made by use of a particle size distribution measuring apparatus, in which a laser diffraction technique is utilized. For example, the mean particle diameter may be evaluated with a technique, wherein volume sphere-equivalent particle diameters are measured by use of a Microtrac particle size distribution measuring apparatus (MT3100II, supplied by Nikkiso Co., Ltd.), and wherein a mass basis mean particle diameter is calculated. Alternatively, the mean particle diameter may be evaluated with a technique, wherein circle-equivalent particle diameters are measured by performing image processing on image information having been obtained with a secondary-electron scanning electron microscope (SEM), and wherein the mass basis mean particle diameter is calculated. In the present invention, the mean particle diameter is specified by the particle size distribution measurement with the laser diffraction technique.

The analysis of the composition may be made with inductively coupled plasma atomic emission spectrometry (ICP-AES) or a fluorescent X-ray analysis technique. In the present invention, unless otherwise specified, the composition analysis is made with the inductively coupled plasma atomic emission spectrometry. With the inductively coupled plasma atomic emission spectrometry, the analysis is made in accordance with the procedure described below.

1. A sample is dissolved in dilute nitric acid with heating, deionized water is added to the resulting solution, and the resulting mixture is subjected to filtration.

2. An undissolved material is melted with sodium carbonate, the resulting melt is dissolved with deionized water with heating, and the resulting solution is rendered acidic with nitric acid and is then combined with the filtrate obtained from the filtration in the step 1 described above, and the combined solution is made up to a constant volume.

3. The solution having been obtained in the step 2 described above is diluted appropriately with dilute nitric acid, the contents of the Bi element and the X element in the sample are obtained with the inductively coupled plasma atomic emission spectrometry, and the relative value is calculated.

### [Radiation Photo-Conductor]

The first radiation photo-conductor in accordance with the present invention is characterized by being produced by use of the Bi₁₂XO₂₀ powder in accordance with the present invention. Also, the second radiation photo-conductor in accordance with the present invention is characterized by containing the Bi₁₂XO₂₀ polycrystal, wherein the polycrystal has the composition satisfying the condition of Formula (2) shown below. Further, the third radiation photo-conductor in accordance with the present invention is characterized by containing the binder and the Bi₁₂XO₂₀ powder, the particles of which have been bound with one another by the binder, wherein the Bi₁₂XO₂₀ powder has the composition satisfying the condition of Formula (2) shown below.

0.94≦X/Bi₁₂≦0.99 (2)

As described above under “Description of the Related Art,” in Japanese Unexamined Patent Publication No. 11(1999)-237478, it is described that a composition of Bi₁₂XO₂₀, wherein the ratio of the molar quantity of the X element to the molar quantity of Bi₁₂ is equal to 1, i.e. the composition having the stoichiometric ratio, is most appropriate for the radiation photo-conductor. However, the inventors have found that, in the use application for the radiation photo-conductor, the composition of Bi₁₂XO₂₀ should most preferably be such that the proportion of Bi is slightly higher with respect to the stoichiometric ratio, i.e. such that the composition satisfies the condition of Formula (2) shown above. Specifically, the radiation photo-conductor containing Bi₁₂XO₂₀ having the composition satisfying the condition of Formula (2) shown above in accordance with the present invention is the novel radiation photo-conductor. The novel radiation photo-conductor in accordance with the present invention has the collected charge characteristics better than the collected charge characteristics of the conventional radiation photo-conductors.

As a technique for preparing the radiation photo-conductor by use of the Bi₁₂XO₂₀ powder, one of the techniques described below may be employed.

A first technique for preparing the radiation photo-conductor by use of the Bi₁₂XO₂₀ powder is the press sintering technique comprising the steps of: molding the Bi₁₂XO₂₀ powder by use of a pressing machine, thereby forming a film of the Bi₁₂XO₂₀ powder, and subjecting the thus formed film to sintering processing.

A second technique for preparing the radiation photo-conductor by use of the Bi₁₂XO₂₀ powder is the green sheet technique comprising the steps of: kneading the Bi₁₂XO₂₀ powder together with a binder and a solvent, thereby preparing a slurry, coating the slurry, drying the thus formed coating layer of the slurry, thereby forming a green sheet (i.e., a film containing the binder), and subjecting the thus formed green sheet to sintering processing for removing the binder from the film and sintering the Bi₁₂XO₂₀ powder. In the cases of the green sheet technique, the binder is utilized. However, the binder is lost completely due to the sintering processing. Therefore, after the sintering processing has been performed, the binder does not remain in the Bi₁₂XO₂₀ sintered material. Preferable examples of the binders, which may be utilized for the green sheet technique, include cellulose acetate, a polyalkyl methacrylate, a polyvinyl alcohol, and a polyvinyl butyral.

A third technique for preparing the radiation photo-conductor by use of the Bi₁₂XO₂₀ powder is the aerosol deposition technique (the AD technique) comprising the steps of: causing the Bi₁₂XO₂₀ powder to fly by a carrier gas in a vacuum, blowing the carrier gas, which contains the Bi₁₂XO₂₀ powder, against a support in a vacuum, and thereby depositing the Bi₁₂XO₂₀ powder on the support. With the AD technique, the particles having been prepared previously are mixed with the carrier gas and are thus aerosolized, the thus formed aerosol is jetted out through a nozzle to a substrate, and a film is thereby formed on the substrate. How the AD technique is performed will be described hereinbelow with reference to FIG. 6. FIG. 6 is a schematic view showing a film forming apparatus for carrying out the AD technique utilized for the production of the radiation photo-conductor in accordance with the present invention.

With reference to FIG. 6, a production apparatus 50 comprises an aerosolizing chamber 52, in which a Bi₁₂XO₂₀ powder 51 and a carrier gas are agitated and mixed together. The production apparatus 50 also comprises a film forming chamber 53, in which film forming processing is performed. The production apparatus 50 further comprises a high-pressure gas cylinder 54, which accommodates the carrier gas. The film forming chamber 53 is provided with a substrate 55, on which the Bi₁₂XO₂₀ powder 51 is to be deposited. The film forming chamber 53 is also provided with a holder 56 for supporting the substrate 55. The film forming chamber 53 is further provided with an XYZθ stage 57 for moving the holder 56 in three-dimensional directions. The film forming chamber 53 is still further provided with a nozzle 58 having a small opening, through which the Bi₁₂XO₂₀ powder 51 is to be jetted out to the substrate 55. The production apparatus 50 still further comprises a first piping 59, which connects the nozzle 58 and the aerosolizing chamber 52 with each other. The production apparatus 50 also comprises a second piping 60, which connects the aerosolizing chamber 52 and the high-pressure gas cylinder 54 with each other. The production apparatus 50 further comprises a vacuum pump 61, which evacuates the region within the film forming chamber 53.

By use of the Bi₁₂XO₂₀ powder 51, which is loaded in the aerosolizing chamber 52, a film is formed on the substrate 55 with the procedure described below. Specifically, the Bi₁₂XO₂₀ powder 51, which has been loaded in the aerosolizing chamber 52, is subjected to vibration and agitation processing together with the carrier gas, which is introduced from the high-pressure gas cylinder 54 accommodating the carrier gas through the second piping 60 and into the aerosolizing chamber 52. In this manner, the Bi₁₂XO₂₀ powder 51 is aerosolized in the aerosolizing chamber 52. The thus aerosolized Bi₁₂XO₂₀ powder 51 passes through the first piping 59 and is jetted out together with the carrier gas from the nozzle 58, which has the small opening and is located in the film forming chamber 53, to the substrate 55. A film of the Bi₁₂XO₂₀ powder 51 is thus formed on the substrate 55. The film forming chamber 53 is evacuated by the vacuum pump 61. When necessary, the degree of vacuum within the film forming chamber 53 is adjusted. Also, the holder 56, which supports the substrate 55, is capable of being moved by the XYZθ stage 57. Therefore, the Bi₁₂XO₂₀ film having a desired thickness is formed at a predetermined area of the substrate 55.

The aerosolized raw material particles pass through the nozzle 58 having the small opening with an opening area of at most 6 mm² and are thus easily accelerated to a flow rate falling within the range of 2 m/sec to 300 m/sec. The raw material particles are thus caused by the carrier gas to impinge upon the substrate 55 and are deposited on the substrate 55. The particles, which have been caused by the carrier gas to impinge upon the substrate 55, are bonded to one another by the impact of the impingement and thereby form the film on the substrate 55. As a result, a dense film is formed. At the time of the deposition of the raw material powder, the substrate 55 may be kept at the room temperature. However, in cases where the temperature of the substrate 55 at the time of the deposition of the raw material powder is adjusted so as to fall within the range of 100° C. to 300° C., a denser film is formed.

By each of the aforesaid first, second, and third techniques for preparing the radiation photo-conductor by use of the Bi₁₂XO₂₀ powder, the second radiation photo-conductor in accordance with the present invention is obtained.

A fourth technique for preparing the radiation photo-conductor by use of the Bi₁₂XO₂₀ powder is the technique comprising the steps of: mixing the Bi₁₂XO₂₀ powder, an organic binder or an inorganic binder, and an appropriate solvent together, thereby preparing a slurry, coating the slurry or loading the slurry into a mold, removing the solvent with drying processing, and thereby preparing a radiation photo-conductor, in which the particles of the Bi₁₂XO₂₀ powder are bound with one another by the organic binder or the inorganic binder. Examples of the organic binders, which may be used in this case, include a polystyrene, a polyimide, and a polyester resin (e.g., Vylon 200, supplied by Toyobo Co., Ltd.). Examples of the inorganic binders, which may be used in this case, include amorphous silica, colloidal silica, an alkyl silicate, a metal alcoholate, mica, silicon, and glass.

By the aforesaid fourth technique for preparing the radiation photo-conductor by use of the Bi₁₂XO₂₀ powder, the third radiation photo-conductor in accordance with the present invention is obtained.

### [Radiation Detector]

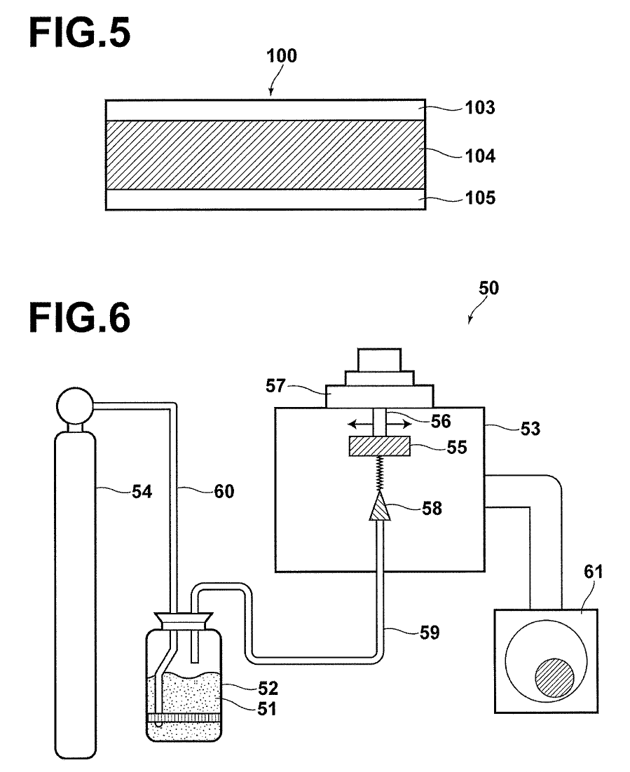

An embodiment of the radiation detector will be described hereinbelow with reference to FIG. 5. FIG. 5 is a schematic sectional view showing an embodiment of a radiation detector. With reference to FIG. 5, a radiation detector 100 comprises a radiation photo-conductor 104. The radiation detector 100 also comprises electrodes 103 and 105 for applying an electric field across the radiation photo-conductor 104. The electrodes 103 and 105 are located on opposite sides of the radiation photo-conductor 104. Radiation having been irradiated to the surfaces of the electrodes 103 and 105 is detected by the radiation photo-conductor 104.

The electrodes 103 and 105 may be constituted of an electrically conductive material, such as indium tin oxide (ITO), Au, or Pt. The applied electric field may fall within the range of 0.1 V/μm to 20 V/μm, and should preferably fall within the range of 2 V/μm to 10 V/μm.

The radiation photo-conductor 104 is obtained by use of the Bi₁₂XO₂₀ powder having been produced by the process for producing a Bi₁₂XO₂₀ powder in accordance with the present invention. The Bi₁₂XO₂₀ powder should preferably have the composition satisfying the condition of Formula (1) shown below, and should more preferably have the composition satisfying the condition of Formula (2) shown below.

0.91≦X/Bi₁₂≦1.09 (1)

0.94≦X/Bi₁₂≦0.99 (2)

The thickness of the radiation photo-conductor 104 may be set appropriately in accordance with the kind of the radiation to be detected. For example, in cases where the radiation is the X-rays for medical diagnosis, the thickness of the radiation photo-conductor 104 should preferably fall within the range of 50 μm to 1,000 μm.

### [Radiation Imaging Panel]

The radiation photo-conductor in accordance with the present invention may be employed for the electric readout type of the radiation imaging panel. With the electric readout type of the radiation imaging panel, the electric charges having been generated with the irradiation of the radiation are accumulated, and the accumulated electric charges are read out through an operation, in which an electric switch, such as a thin film transistor (TFT), a charge coupled device (CCD), or a complementary metal oxide semiconductor (CMOS) sensor, is turned on and off with respect to each of pixels. The radiation photo-conductor in accordance with the present invention may be employed for the optical readout type of the radiation imaging panel, in which the readout operation is performed by use of a radiation image detector utilizing a semiconductor material for generating the electric charges when being exposed to light.

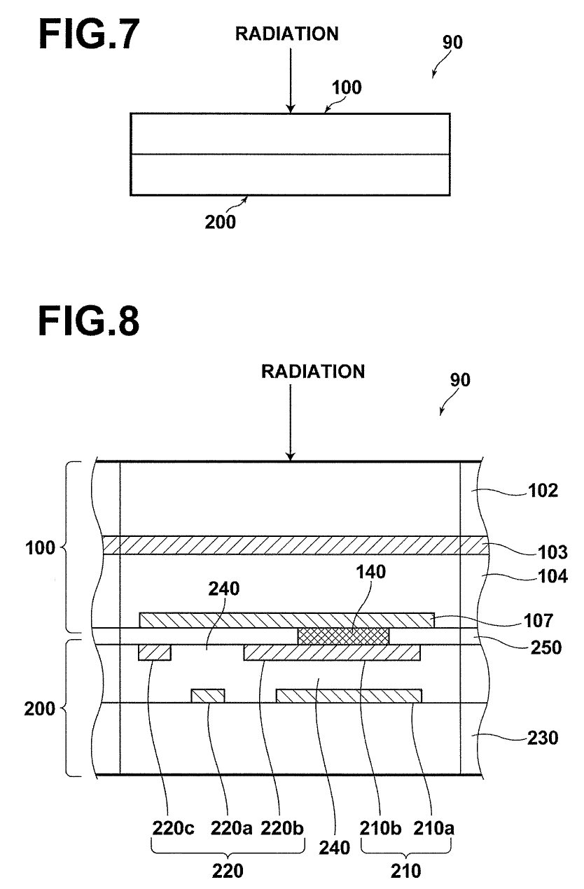

Firstly, as an example of the electric readout type of the radiation imaging panel, a TFT readout type of radiation imaging panel will be described hereinbelow with reference to FIG. 7 and FIG. 8. FIG. 7 is an explanatory view showing a radiation detecting section and an AMA board, which are combined together. FIG. 8 is a schematic sectional view showing regions of the radiation detecting section and the AMA board, which regions correspond to one pixel. As illustrated in FIG. 7, a TFT readout type of radiation imaging panel 90 has a structure, in which a radiation detecting section 100 and an active matrix array board (AMA board) (acting as the electric current detecting means) 200 has been joined together. As illustrated in FIG. 8, the radiation detecting section 100 comprises a common electrode 103 for application of a bias voltage. The radiation detecting section 100 also comprises a radiation photo-conductor layer 104, which is sensitive to the radiation to be detected and forms carriers constituted of electron-hole pairs. The radiation detecting section 100 further comprises a detection electrode 107 for collecting the carriers. The common electrode 103, the radiation photo-conductor layer 104, and the detection electrode 107 are overlaid in this order from the radiation incidence side. A radiation detecting section support 102 may be located as a top layer on the common electrode 103.

The radiation photo-conductor layer 104 is the radiation photo-conductor in accordance with the present invention. Each of the common electrode 103 and the detection electrode 107 may be constituted of an electrically conductive material, such as indium tin oxide (ITO), Au, or Pt. In accordance with the polarity of the bias voltage, a hole injection blocking layer or an electron injection blocking layer may be appended to the common electrode 103 or the detection electrode 107.

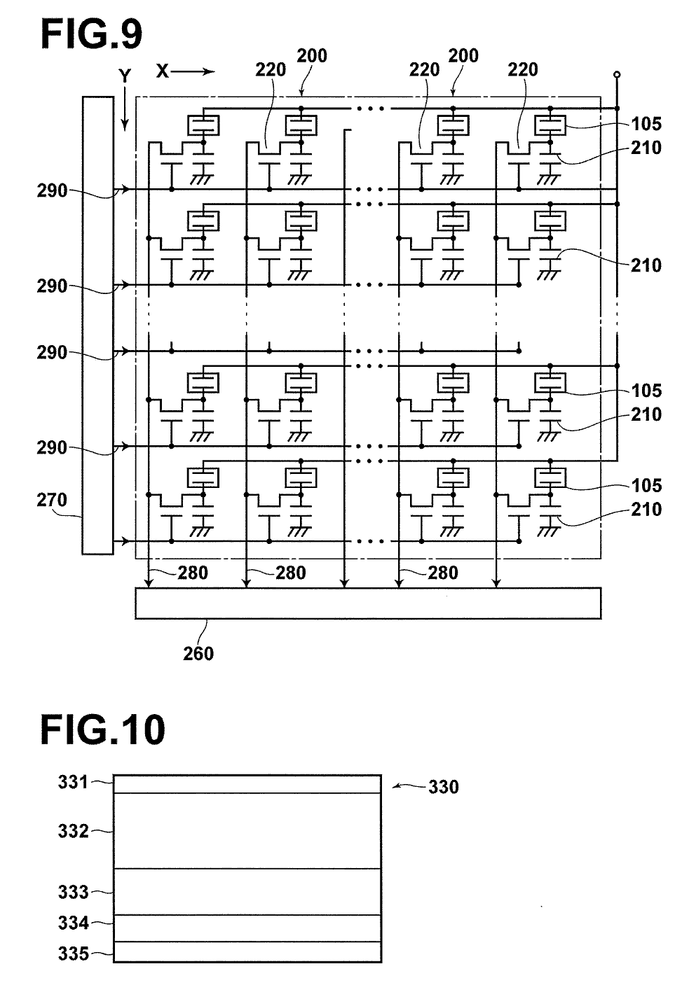

The constitution of the AMA board 200 will hereinbelow be described briefly. FIG. 9 is an electric circuit diagram showing an equivalent circuit of the AMA board. As illustrated in FIG. 9, the AMA board 200 comprises capacitors 210, 210, . . . acting as charge accumulating capacitors and TFT's 220, 220, . . . acting as switching devices. One capacitor 210 and one TFT 220 are located for each of radiation detecting sections 105, 105, . . . , which correspond respectively to the pixels. On the radiation detecting section support 102, in accordance with the necessary pixels, the radiation detecting sections 105, 105, . . . corresponding to the pixels are arrayed in two-dimensional directions in a pattern of a matrix comprising approximately 1,000˜3,000 rows×1,000˜3,000 columns. Also, in the AMA board 200, the same number of the capacitors 210, 210, . . . and the same number of the TFT's 220, 220, . . . as the number of the pixels are arrayed in two-dimensional directions in the same matrix pattern as that described above. The electric charges, which have been generated in the radiation photo-conductor layer 104, are accumulated in each of the capacitors 210, 210, . . . and act as the electrostatic latent image. In the cases of the TFT readout type of the radiation imaging panel, the electrostatic latent image having been formed with the radiation is kept at the charge accumulating capacitors.

The specific constitutions of each of the capacitors 210, 210, . . . and each of the TFT's 220, 220, . . . of the AMA board 200 are illustrated in FIG. 8. Specifically, an AMA board support 230 is constituted of an electrical insulator. A grounding side electrode 210a of the capacitor 210 and a gate electrode 220a of the TFT 220 are formed on the surface of the AMA board support 230. Above the grounding side electrode 210a of the capacitor 210 and the gate electrode 220a of the TFT 220, a connection side electrode 210b of the capacitor 210 is formed via an insulating film 240. Also, above the grounding side electrode 210a of the capacitor 210 and the gate electrode 220a of the TFT 220, a source electrode 220b and a drain electrode 220c of the TFT 220 are formed via the insulating film 240. Further, the top surface of the AMA board 200 is covered with a protective insulating film 250. The connection side electrode 210b of the capacitor 210 and the source electrode 220b of the TFT 220 are connected with each other and are formed together with each other. The insulating film 240 constitutes both the capacitor insulating film of the capacitor 210 and the gate insulating film of the TFT 220. The insulating film 240 may be constituted of, for example, a plasma SiN film. The AMA board 200 may be produced by use of a thin film forming technique or a fine processing technique, which is ordinarily employed for the production of a liquid crystal display board.

The joining of the radiation detecting section 100 and the AMA board 200 will be described hereinbelow. Specifically, the position of the detection electrode 107 and the position of the connection side electrode 210b of the capacitor 210 are matched with each other. In this state, the radiation detecting section 100 and the AMA board 200 are laminated together by adhesion under heating and under pressure with an anisotropic electrically conductive film (ACF) intervening therebetween. The ACF contains electrically conductive particles, such as silver particles, and has the electrical conductivity only in the thickness direction. In this manner, the radiation detecting section 100 and the AMA board 200 are mechanically combined with each other. At the same time, the detection electrode 107 and the connection side electrode 210b are electrically connected with each other by an intervening conductor section 140.

Also, the AMA board 200 is provided with a readout actuating circuit 260 and a gate actuating circuit 270. As illustrated in FIG. 9, the readout actuating circuit 260 is connected to each of readout wiring lines (readout address lines) 280, 280, . . . . Each of the readout wiring lines 280, 280, . . . extends in the vertical (Y) direction and connects the drain electrodes 220c, 220c, . . . of the TFT's 220, 220, . . . , which are arrayed along an identical column. The gate actuating circuit 270 is connected to each of readout wiring lines (gate address lines) 290, 290, . . . . Each of the readout wiring lines 290, 290, . . . extends in the horizontal (X) direction and connects the gate electrodes 220a, 220a, . . . of the TFT's 220, 220, . . . , which are arrayed along an identical row. Though not shown, in the readout actuating circuit 260, one pre-amplifier (one electric charge-to-voltage converter) is connected to each of the readout wiring lines 280, 280, . . . . In this manner, the AMA board 200 is connected to the readout actuating circuit 260 and the gate actuating circuit 270. Alternatively, the readout actuating circuit 260 and the gate actuating circuit 270 may be formed into an integral body within the AMA board 200.

The radiation detecting operations performed by the radiation image recording and read-out system, which comprises the radiation detecting section 100 and the AMA board 200 joined together, are described in, for example, Japanese Unexamined Patent Publication No. 11(1999)-287862.

The optical readout type of the radiation imaging panel will be described hereinbelow with reference to FIG. 10. FIG. 10 is a sectional view showing an embodiment of a radiation imaging panel, which comprises a radiation photo-conductor in accordance with the present invention.

With reference to FIG. 10, a radiation imaging panel 330 comprises a first electrical conductor layer 331, which has transmissivity to recording radiation L1 described later. The radiation imaging panel 330 also comprises a recording radio-conductor layer 332, which exhibits electrical conductivity when it is exposed to the radiation L1 having passed through the first electrical conductor layer 331. The radiation imaging panel 330 further comprises a charge transporting layer 333, which acts approximately as an insulator with respect to electric charges (latent image polarity charges, e.g. negative charges) having a polarity identical with the polarity of electric charges occurring in the first electrical conductor layer 331, and which acts approximately as a conductor with respect to electric charges (transported polarity charges, positive charges in this example) having a polarity opposite to the polarity of the electric charges occurring in the first electrical conductor layer 331. The radiation imaging panel 330 still further comprises a reading photo-conductor layer 334, which exhibits electrical conductivity when it is exposed to reading light L2 described later, and a second electrical conductor layer 335 having transmissivity to the reading light L2. The first electrical conductor layer 331, the recording radio-conductor layer 332, the charge transporting layer 333, the reading photo-conductor layer 334, and the second electrical conductor layer 335 are overlaid in this order.

As each of the first electrical conductor layer 331 and the second electrical conductor layer 335, a film of an electrically conductive substance uniformly coated on a transparent glass plate (NESA film, which is a tin dioxide film, or the like) may be employed.

The charge transporting layer 333 may be constituted of one of various materials, which have the characteristics such that the difference between the mobility of the negative electric charges occurring in the first electrical conductor layer 331 and the mobility of the positive electric charges is large. The charge transporting layer 333 should preferably be constituted of, for example, an organic compound, such as a poly-N-vinylcarbazole (PVK), N,N′-diphenyl-N,N′-bis(3-methylphenyl)-[1,1′-biphenyl]-4,4′-diamine (TPD), or a discotic liquid crystal; or a semiconductor substance, such as a polymer (polycarbonate, polystyrene, PVK) dispersion of TPD, or a-Se doped with 10 ppm to 200 ppm of Cl. In particular, the organic compound (PVK, TPD, or the discotic liquid crystal) has light insensitivity and is therefore preferable. Also, since the permittivity is ordinarily low, the capacity of the charge transporting layer 333 and the capacity of the reading photo-conductor layer 334 become small, and the signal take-out efficiency at the time of readout is kept high.

The reading photo-conductor layer 334 should preferably be constituted of, for example, a photo-conductive material containing, as a principal constituent, at least one substance selected from the group consisting of a-Se, Se—Te, Se—As—Te, metal-free phthalocyanine, metallo-phthalocyanine, magnesium phthalocyanine (MgPc), phase II of vanadyl phthalocyanine (VoPc), and copper phthalocyanine (CuPc).

As the recording radio-conductor layer 332, the radiation photo-conductor in accordance with the present invention is employed. Specifically, the radiation photo-conductor in accordance with the present invention is the recording radio-conductor layer.

The optical readout technique for reading out the electrostatic latent image will hereinbelow be described briefly.

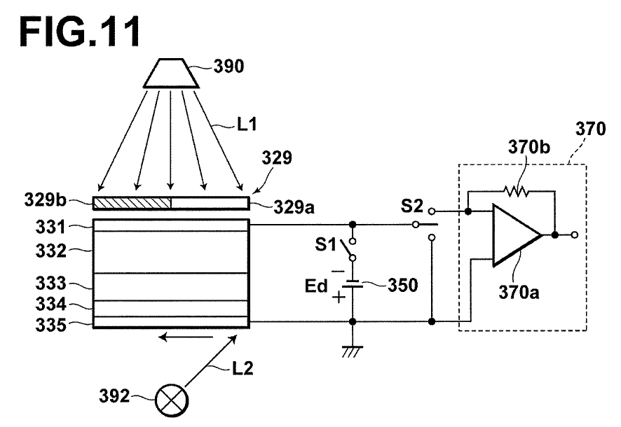

FIG. 11 is a schematic view showing a recording and readout system (i.e., a combination of an electrostatic latent image recording apparatus and an electrostatic latent image readout apparatus), in which the radiation imaging panel 330 of FIG. 10 is employed. With reference to FIG. 11, the recording and readout system comprises the radiation imaging panel 330 and recording irradiation means 390. The recording and readout system also comprises an electric power source 350 and electric current detecting means 370. The recording and readout system further comprises readout exposure means 392, connection means S1, and connection means S2. The electrostatic latent image recording apparatus is constituted of the radiation imaging panel 330, the electric power source 350, the recording irradiation means 390, and the connection means S1. The electrostatic latent image readout apparatus is constituted of the radiation imaging panel 330, the electric current detecting means 370, and the connection means S2.

The first electrical conductor layer 331 of the radiation imaging panel 330 is connected via the connection means S1 to a negative pole of the electric power source 350. The first electrical conductor layer 331 of the radiation imaging panel 330 is also connected to one end of the connection means S2. One terminal of the other end of the connection means S2 is connected to the electric current detecting means 370. The second electrical conductor layer 335 of the radiation imaging panel 330, a positive pole of the electric power source 350, and the other terminal of the other end of the connection means S2 are grounded. The electric current detecting means 370 comprises a detection amplifier 370a, which is constituted of an operational amplifier, and a feedback resistor 370b. The electric current detecting means 370 thus constitutes a current-to-voltage converting circuit.

An object 329 is placed at the top surface of the first electrical conductor layer 331. The object 329 has a transmissive region 329a, which has the transmissivity to the radiation L1, and a light blocking region 329b, which does not have the transmissivity to the radiation L1. The recording irradiation means 390 uniformly irradiates the radiation L1 to the object 329. With the read-out exposure means 392, the reading light L2, such as an infrared laser beam, an LED light, or an EL light, is scanned in the direction indicated by the arrow in FIG. 11. The reading light L2 should preferably have a beam shape having been converged into a small beam diameter.

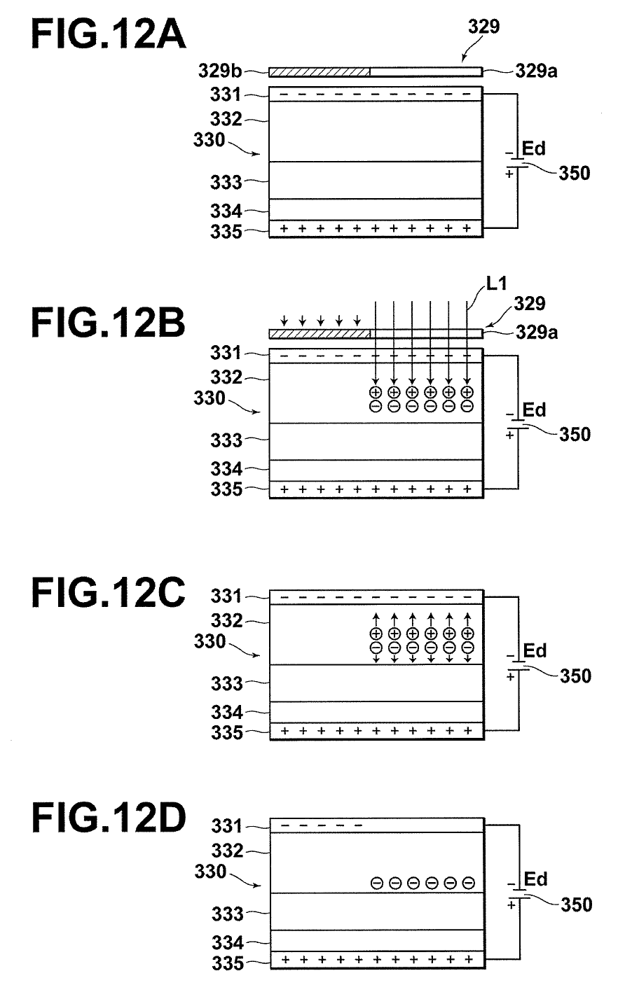

An electrostatic latent image recording stage in the recording and readout system of FIG. 11 will be described hereinbelow with reference to FIGS. 12A to 12D. FIGS. 12A to 12D are explanatory views showing electric charge models for explanation of an electrostatic latent image recording stage in the recording and readout system of FIG. 11. The connection means S2 illustrated in FIG. 11 is set in an open state (in which the connection means S2 is not connected to the ground nor to the electric current detecting means 370). Also, as illustrated in FIG. 12A, the connection means S1 illustrated in FIG. 11 is set in the on state, and a d.c. voltage Ed supplied by the electric power source 350 is applied between the first electrical conductor layer 331 and the second electrical conductor layer 335. As a result, the negative charges occur in the first electrical conductor layer 331, and the positive charges occur in the second electrical conductor layer 335. In this manner, a parallel electric field is formed between the first electrical conductor layer 331 and the second electrical conductor layer 335.

Thereafter, as illustrated in FIG. 12B, the radiation L1 is uniformly irradiated from the recording irradiation means 390 toward the object 329. The radiation L1, which has been produced by the recording irradiation means 390, passes through the transmissive region 329a of the object 329. The radiation L1 then passes through the first electrical conductor layer 331 and impinges upon the recording radio-conductor layer 332. When the recording radio-conductor layer 332 receives the radiation L1 having passed through the first electrical conductor layer 331, the recording radio-conductor layer 332 exhibits the electrical conductivity. The characteristics of the recording radio-conductor layer 332 for exhibiting the electrical conductivity are capable of being found from the characteristics in that the recording radio-conductor layer 332 acts as a variable resistor exhibiting a resistance value variable in accordance with the dose of the radiation L1. The resistance value depends upon the occurrence of electric charge pairs of electrons (negative charges) and holes (positive charges) due to the radiation L1. In cases where the dose of the radiation L1, which has passed through the object 329, is small, a large resistance value is exhibited. In FIG. 12B, the negative charges (−) formed by the radiation L1 are represented by “−” surrounded by the “o” mark, and the positive charges (+) formed by the radiation L1 are represented by “+” surrounded by the “o” mark.

As illustrated in FIG. 12C, the positive charges, which have occurred in the recording radio-conductor layer 332, quickly migrate through the recording radio-conductor layer 332 toward the first electrical conductor layer 331. Also, as illustrated in FIG. 12D, the positive charges, which have migrated through the recording radio-conductor layer 332 toward the first electrical conductor layer 331, undergo charge re-combination with the negative charges, which have been formed in the first electrical conductor layer 331. The charge re-combination occurs at the interface between the first electrical conductor layer 331 and the recording radio-conductor layer 332, and the positive charges described above disappear. Also, as illustrated in FIG. 12C, the negative charges, which have occurred in the recording radio-conductor layer 332, migrate through the recording radio-conductor layer 332 toward the charge transporting layer 333. The charge transporting layer 333 acts as the insulator with respect to the electric charges (in this example, the negative charges) having the polarity identical with the polarity of the electric charges occurring in the first electrical conductor layer 331. Therefore, as illustrated in FIG. 12D, the negative charges, which have migrated through the recording radio-conductor layer 332 toward the charge transporting layer 333, cease at the interface between the recording radio-conductor layer 332 and the charge transporting layer 333 and are accumulated at the interface between the recording radio-conductor layer 332 and the charge transporting layer 333. The quantity of the electric charges, which are thus accumulated, is defined by the quantity of the negative charges occurring in the recording radio-conductor layer 332, i.e. the dose of the radiation L1 having passed through the object 329.

The radiation L1 does not pass through the light blocking region 329b of the object 329. Therefore, as illustrated in FIGS. 12B, 12C, and 12D, a change does not occur at the region of the radiation imaging panel 330, which region is located under the light blocking region 329b of the object 329. In the manner described above, in cases where the radiation L1 is irradiated to the object 329, electric charges in accordance with the object image are capable of being accumulated at the interface between the recording radio-conductor layer 332 and the charge transporting layer 333. The object image, which is formed with the thus accumulated electric charges, is referred to as the electrostatic latent image.

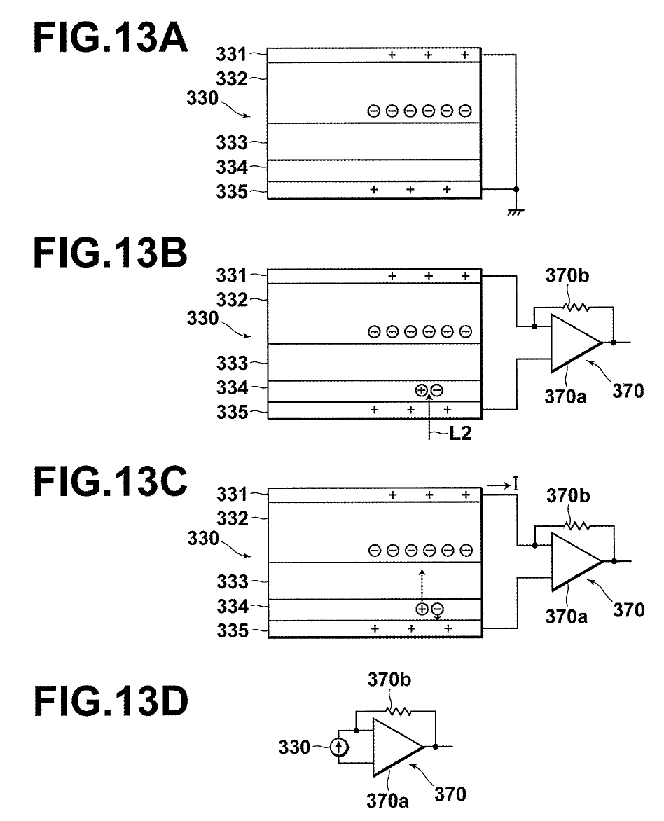

An electrostatic latent image readout stage in the recording and readout system of FIG. 11 will be described hereinbelow with reference to FIGS. 13A to 13D. FIGS. 13A to 13D are explanatory views showing electric charge models for explanation of an electrostatic latent image readout stage in the recording and readout system of FIG. 11. The connection means S1 illustrated in FIG. 11 is set in the open state, and the supply of the electric power is ceased. Also, as illustrated in FIG. 13A, the connection means S2 illustrated in FIG. 11 is connected to the ground side. In this manner, the first electrical conductor layer 331 and the second electrical conductor layer 335 of the radiation imaging panel 330, on which the electrostatic latent image has been recorded, are set at the identical electric potential, and re-arrangement of the electric charges is performed. Thereafter, the connection means S2 is connected to the side of the electric current detecting means 370.

Also, as illustrated in FIG. 13B, with the readout exposure means 392, the scanning with the reading light L2 is performed from the side of the second electrical conductor layer 335 of the radiation imaging panel 330. The reading light L2 impinging upon the second electrical conductor layer 335 passes through the second electrical conductor layer 335 and impinges upon the reading photo-conductor layer 334. When the reading photo-conductor layer 334 is exposed to the reading light L2, which has passed through the second electrical conductor layer 335, the reading photo-conductor layer 334 exhibits the electrical conductivity in accordance with the scanning exposure. As in the cases of the characteristics of the recording radio-conductor layer 332 for exhibiting the electrical conductivity due to the occurrence of the pairs of the positive and negative charges when the recording radio-conductor layer 332 is exposed to the radiation L1, the characteristics of the reading photo-conductor layer 334 for exhibiting the electrical conductivity depend upon the occurrence of the pairs of the positive and negative charges when the reading photo-conductor layer 334 is exposed to the reading light L2. As in the cases of the electrostatic latent image recording stage, in FIG. 13B, the negative charges (−) formed by the reading light L2 are represented by “−” surrounded by the “o” mark, and the positive charges (+) formed by the reading light L2 are represented by “+” surrounded by the “o” mark.

The charge transporting layer 333 acts as the electrical conductor with respect to the positive charges. Therefore, as illustrated in FIG. 13C, the positive charges, which have occurred in the reading photo-conductor layer 334, quickly migrate through the charge transporting layer 333 by being attracted by the negative charges, which have been accumulated at the interface between the recording radio-conductor layer 332 and the charge transporting layer 333. The positive charges, which have thus migrated through the charge transporting layer 333, undergo the charge re-combination with the accumulated negative charges at the interface between the recording radio-conductor layer 332 and the charge transporting layer 333 and disappear. Also, as illustrated in FIG. 13C, the negative charges, which have occurred in the reading photo-conductor layer 334, undergo the charge re-combination with the positive charges of the second electrical conductor layer 335 and disappear. The reading photo-conductor layer 334 is scanned with the reading light L2 having a sufficient optical intensity, and all of the accumulated electric charges, which have been accumulated at the interface between the recording radio-conductor layer 332 and the charge transporting layer 333, i.e. the electrostatic latent image, disappear through the charge re-combination. The disappearance of the electric charges, which have been accumulated in the radiation imaging panel 330, means the state, in which an electric current I flows across the radiation imaging panel 330 due to the migration of the electric charges. The state, in which the electric current I flows across the radiation imaging panel 330 due to the migration of the electric charges, is capable of being represented by an equivalent circuit illustrated in FIG. 13D, in which the radiation imaging panel 330 is represented by the electric current source having the electric current quantity depending upon the quantity of the accumulated electric charges.

As described above, the scanning of the radiation imaging panel 330 with the reading light L2 is performed, and the electric current flowing across the radiation imaging panel 330 is detected. In this manner, the quantity of the accumulated electric charges, which have been accumulated at each of scanned regions (corresponding to pixels), is capable of being detected. The electrostatic latent image is thus capable of being read out. The operations of the radiation detecting section are described in, for example, U.S. Pat. No. 6,268,614.

The present invention will further be illustrated by the following non-limitative examples.

### EXAMPLES

### Example 1

Firstly, 279.6 g of bismuth oxide (supplied by Kojundo Chemical Laboratory Co., Ltd., purity: 5N) was dissolved by use of 474.4 g of nitric acid (supplied by Wako Pure Chemical Industries, Ltd., concentration: 61.1 wt %) and deionized water, and one liter of a solution (Bi solution: B-1) containing the Bi element in a concentration of 1.2 mol/l was thereby prepared. Also, 30.1 g of a potassium silicate solution (supplied by Wako Pure Chemical Industries, Ltd., molar ratio: SiO₂/K₂O=3.9, concentration: 28.0%), 700 ml of a potassium hydroxide solution (supplied by Wako Pure Chemical Industries, Ltd., 8N), and deionized water were mixed together, and one liter of a solution (Si solution: S-1) containing the Si element in a concentration of 0.1 mol/l was thereby prepared. Further, 500 ml of an alkaline mother liquor (mother liquor: M-1) was prepared by use of 62.5 ml of a potassium hydroxide solution (supplied by Wako Pure Chemical Industries, Ltd., 8N) and deionized water. By use of the solutions having been prepared in the manner described above, synthesis of a Bi₁₂SiO₂₀ powder was performed with the reaction apparatus 1 illustrated in FIG. 1.

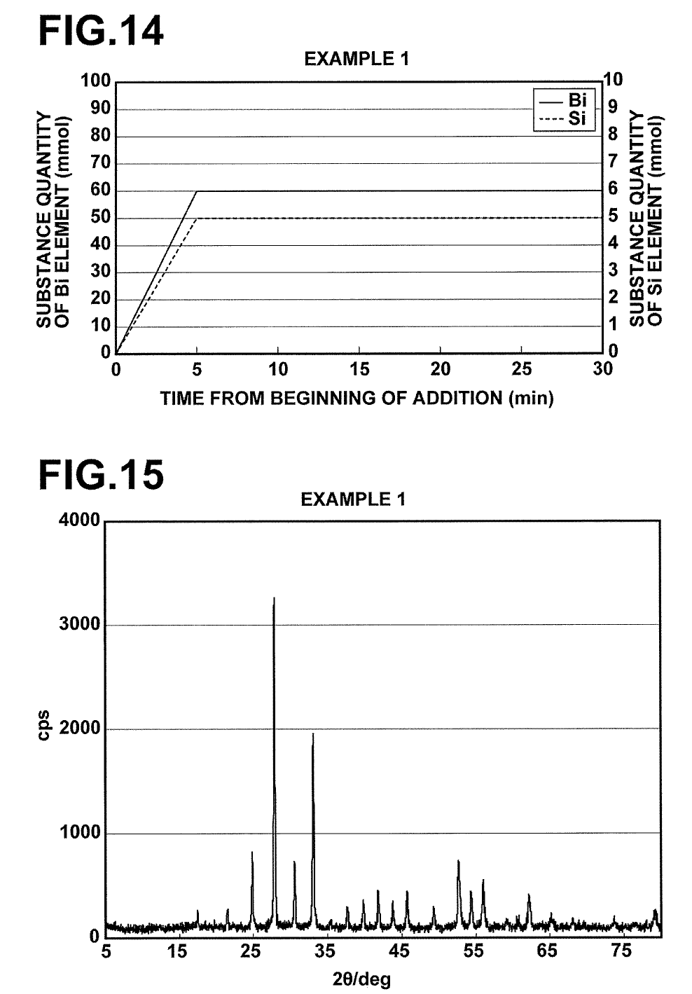

Specifically, 500 ml of the mother liquor (M-1) was introduced into the reaction chamber 21 having been coated with Teflon®. The temperature of the mother liquor (M-1) was raised to 50° C., while the agitating section 11 was being operated at a rotation speed of 1,000 rpm in the mother liquor (M-1). The agitating section 11 used in this case had a constitution, such that a propeller type agitating blade was provided within a cylinder located at the middle of a bottom region of the reaction chamber 21, and such that the Bi solution and the Si solution was capable of being directly added into the inside region of the cylinder. Thereafter, the Bi solution (B-1, 50 ml) accommodated in the solution tank 24a and the Si solution (S-1, 50 ml) accommodated in the solution tank 24b were added through the liquid feeding flow path 25a and the liquid feeding flow path 25b, respectively, simultaneously with each other at a feed rate of 10 ml/min over a period of time of five minutes into the inside region of the cylinder of the agitating section 11. During the addition, the temperature of the mixed liquid in the reaction chamber 21 was kept at 50° C. After the addition was finished, the temperature of the mixed liquid was raised to 75° C. at a temperature rise rate of 2.5° C./min over a period of time of 10 minutes. After the temperature raising was finished, the agitation was continued at a temperature of 75° C. for 120 minutes. FIG. 14 is a graph showing the relationship between the substance quantities of the Bi element and the Si element which were present in the mixed liquid during the addition of the raw material solutions and at the initial stage of the reaction in Example 1. As illustrated in FIG. 14, the ratio between the substance quantity of the Bi element and the substance quantity of the X element was substantially kept at a predetermined value.

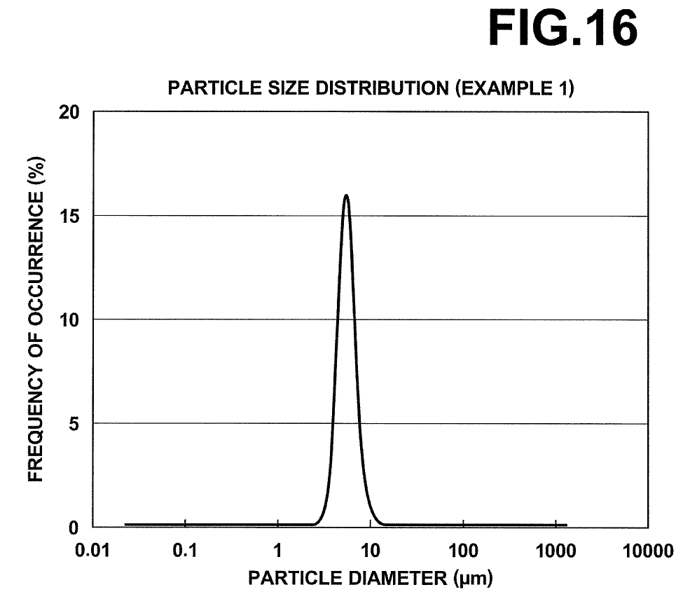

After the agitation was finished, the entire reaction system was cooled to the room temperature. The resulting precipitate was collected by filtration and was sufficiently washed with deionized water. The thus obtained solid material was dried at a temperature of 100° C. for 12 hours, and 12.5 g of a Bi₁₂SiO₂₀ powder was thus obtained (yield: 88%). The identification of the crystal phase of the Bi₁₂SiO₂₀ powder having been produced was performed by use of the powder X-ray diffraction technique (X-ray diffraction apparatus Ultima III, supplied by Rigaku Corporation). As illustrated in FIG. 15, it was confirmed that the crystal phase was the Bi₁₂SiO₂₀ single phase (coinciding with PDF37-0485). The particle diameters of the particles in the obtained powder were measured by use of the laser diffraction type particle size distribution measuring apparatus (particle size distribution measuring apparatus: Microtrac MT3100II, supplied by Nikkiso Co., Ltd.), and it was confirmed that the mean particle diameter was equal to 5.2 μm. The results as illustrated in FIG. 16 were obtained. As clear from FIG. 16, it was found that the Bi₁₂SiO₂₀ powder having a markedly sharp particle size distribution and high uniformity was obtained. Also, observation of an electron microscope image was performed (electron microscope apparatus: S3400, supplied by Hitachi, Ltd.), and it was confirmed that the mean particle diameter was equal to approximately 5 μm. The analysis of the composition of the obtained powder was made with the inductively coupled plasma atomic emission spectrometry, and it was confirmed that Si/Bi₁₂=0.96.

### Example 2

The same experiment as that in Example 1 was additionally iterated two times, and the reproducibility of the production in Example 1 was confirmed. The mean particle diameter of the obtained powder was equal to 5.0 μm and 5.4 μm, and the value of Si/Bi₁₂ was equal to 0.97 and 0.96.

From the results of Example 1 and the two times of the experiments performed in Example 2, it was found that the Bi₁₂SiO₂₀ powder exhibiting little variation in composition among different production lots was obtained with the process for producing a Bi₂SiO₂₀ powder in accordance with the present invention.

### Example 3

A Bi₁₂SiO₂₀ powder was produced in the same manner as that in Example 1, except that the concentration of potassium hydroxide in the Si solution and the concentration of potassium hydroxide in the mother liquor were altered as listed in Table 1 below, and except that the concentration of potassium hydroxide in the reaction system was thereby altered. The preparation conditions and the pH values of the Si solution and the mother liquor were set as listed in Table 1 below.

TABLE 1

| | | Si solution | | | Mother liquor | | |
|---|---|---|---|---|---|---|---|
| | | | | Total | | | Total |
| | | | KOH solution | quantity | | KOH solution | quantity |
| | | Solution | (8N) | prepared | Solution | (8N) | prepared |
| | pH | name | ml | Liter | name | ml | ml |
| Example 1 | 14.0 | S-1 | 700 | 1 | M-1 | 62.5 | 500 |
| Example 3-1 | 12.0 | S-3-1 | 578 | 1 | M-3-1 | 0.63 | 500 |
| Example 3-2 | 12.5 | S-3-2 | 581 | 1 | M-3-2 | 1.98 | 500 |
| Example 3-3 | 13.0 | S-3-3 | 589 | 1 | M-3-3 | 6.25 | 500 |
| Example 3-4 | 13.5 | S-3-4 | 616 | 1 | M-3-4 | 19.8 | 500 |
| Example 3-5 | 14.5 | S-3-5 | 973 | 1 | M-3-5 | 198 | 500 |

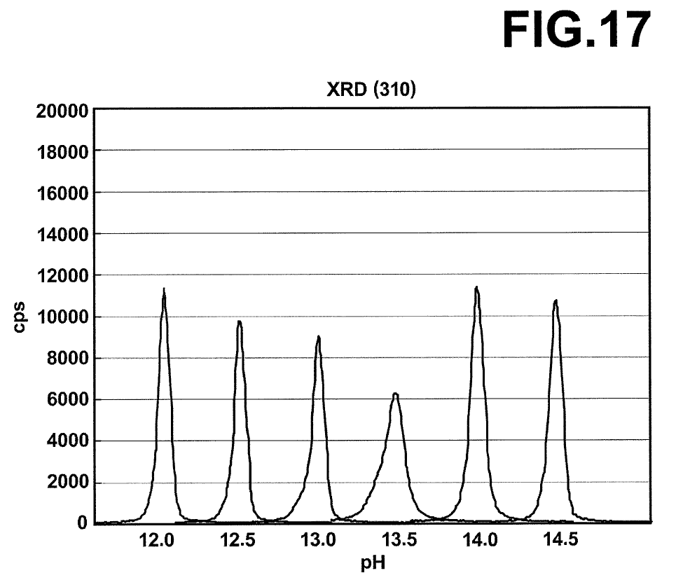

In each of Examples 3-1 through 3-5, the pH value was altered as listed in Table 1. With respect to the Bi₁₂SiO₂₀ powder obtained in each of Examples 3-1 through 3-5 and the Bi₁₂SiO₂₀ powder obtained in Example 1, X-ray diffraction measurement results as shown in FIG. 17 were obtained (310 face, main peak, 2θ: in the vicinity of 27.9°). From FIG. 17, it was found that, within the range of pH12 to pH13.5, there was a tendency for the diffraction peak intensity to become low, and there was a tendency for the diffraction width to become large. It was also found that, at the pH value of at least 14, the results deviated from the tendencies described above. It was thus suggested that a reaction mode at a pH value of at most 13.5 and the reaction mode at a pH value of at least 14 varied from each other.

### Example 4

Firstly, one liter of a Bi solution (B-4) was prepared by use of 582.1 g of bismuth nitrate pentahydrate (Bi(NO₃)₃.5H₂O, supplied by Kojundo Chemical Laboratory Co., Ltd., purity: 3N), 474.4 g of nitric acid (supplied by Wako Pure Chemical Industries, Ltd., concentration: 61.1 wt %), and deionized water. A Bi₁₂SiO₂₀ powder was produced in the same manner as that in Example 1, except that B-4 was used as the Bi solution.

### Example 5

A mixture of 20.83 g of tetraethoxysilane (supplied by Kojundo Chemical Laboratory Co., Ltd., purity: 6N) and 40 g of ethanol was added to 2,033 g of an aqueous tetramethylammonium hydroxide solution (supplied by Wako Pure Chemical Industries, Ltd., concentration: 25 wt %). The resulting mixture was agitated at a temperature of 80° C. for one hour. After ethanol was then removed at reduced pressure, deionized water was added appropriately, and one liter of an Si solution (S-5) was thus prepared. A Bi₁₂SiO₂₀ powder was produced in the same manner as that in Example 1, except that S-5 was used as the Si solution.

### Example 6

Firstly, 10.46 g of a germanium oxide powder (supplied by Kojundo Chemical Laboratory Co., Ltd., purity: 4N) was added to 2,033 g of an aqueous tetramethylammonium hydroxide solution (supplied by Wako Pure Chemical Industries, Ltd., concentration: 25 wt %). The germanium oxide powder was dissolved at a temperature of 60° C. over a period of time of three hours. Thereafter, deionized water was added, and one liter of a Ge solution (G-6) was thus prepared. A Bi₁₂GeO₂₀ powder was produced in the same manner as that in Example 1, except that, in lieu of the Si solution being used, G-6 was used as the Ge solution. Table 2 below shows details of the raw materials, the mean particle size, and X/Bi₁₂ in each of Examples 1, 4, 5, and 6. As shown in Table 2, it was found that, in each of Examples 4, 5, and 6, wherein the raw materials of the Bi solution and the X solution in Example 1 were altered, the Bi₁₂XO₂₀ powder having been produced by the production process in accordance with the present invention had uniform composition and the mean particle diameter which is not susceptible to agglomeration.

TABLE 2

| | | | | | Mother | | Mean | |
|---|---|---|---|---|---|---|---|---|
| | Bi solution | | X solution | | liquor | Crystal | particle | |
| | Bi source | Acid | X source | Alkali | Alkali | phase | size (μm) | X/Bi₁₂ |
| Example 1 | Bi₂O₃ | Nitric | Potassium | Potassium | Potassium | Bi₁₂SiO₂₀ | 5.2 | 0.96 |
| | | acid | silicate | hydroxide | hydroxide | single | | |
| | | | | | | phase | | |
| Example 4 | Bismuth | Nitric | Potassium | Potassium | Potassium | Bi₁₂SiO₂₀ | 5.2 | 0.97 |
| | nitrate | acid | silicate | hydroxide | hydroxide | single | | |
| | | | | | | phase | | |
| Example 5 | Bi₂O₃ | Nitric | Tetra- | Tetra- | Potassium | Bi₁₂SiO₂₀ | 4.8 | 0.98 |
| | | acid | ethoxy- | methyl- | hydroxide | single | | |
| | | | silane | ammonium | | phase | | |
| | | | | hydroxide | | | | |
| Example 6 | Bi₂O₃ | Nitric | Germanium | Tetra- | Potassium | Bi₁₂GeO₂₀ | 7.5 | 0.97 |
| | | acid | oxide | methyl- | hydroxide | single | | |
| | | | | ammonium | | phase | | |
| | | | | hydroxide | | | | |

### Example 7

A Bi₁₂SiO₂₀ powder was produced in the same manner as that in Example 1, except that the reaction apparatus 2 provided with the propeller blade type agitating section 12 made from Teflon® as illustrated in FIG. 2 was used, and except that the Bi solution (B-1) and the Si solution (S-1) were added through the liquid feeding flow paths 25a and 25b constituted of tubes made from Teflon®, respectively, to the positions in the vicinity of the agitating section 12.

### Example 8

A Bi₁₂SiO₂₀ powder was produced in the same manner as that in Example 1, except that the reaction apparatus 3 provided with the propeller blade type agitating section 12 made from Teflon® as illustrated in FIG. 3 was used, except that the Bi solution (B-1) and the Si solution (S-1) were added through the liquid feeding flow paths 25a and 25b, respectively, to the mother liquor from above the top surface of the mother liquor, and except that the agitation, which was performed after the temperature of the mixed liquid in the reaction chamber 21 had been raised to 75° C., was carried out for 48 hours.

### Example 9

A Bi₁₂SiO₂₀ powder was produced in the same manner as that in Example 1, except that the reaction apparatus 4 provided with the shearing type agitating section 14 as illustrated in FIG. 4 was used, and except that the Bi solution (B-1) and the Si solution (S-1) were added through the liquid feeding flow paths 25a and 25b constituted of tubes made from Teflon®, respectively, to the positions in the vicinity of the shearing type agitating section 14.

Table 3 below shows the mean particle size and X/Bi₁₂ in each of Examples 1, 7, 8, and 9. As shown in Table 3, it was found that, in each of Examples 7, 8, and 9, wherein the reaction apparatus in Example 1 was altered, the Bi₁₂XO₂₀ powder having been produced by the production process in accordance with the present invention had uniform composition and the mean particle diameter which is not susceptible to agglomeration. In Examples 1, 7, and 9, the double jet technique, in which the raw material solutions added are immediately mixed uniformly, was employed. In Example 8, wherein the top surface addition technique for adding the raw material solutions from above the mother liquor was employed, since the raw material solutions did not become uniform in the mother liquor, X/Bi₁₂ became large.

TABLE 3

| | | | Mean | |
|---|---|---|---|---|
| | Reaction | Crystal | particle | |
| | apparatus | phase | size (μm) | X/Bi₁₂ |
| Example 1 | Reaction | Bi₁₂SiO₂₀ | 5.2 | 0.96 |
| | apparatus 1 | single phase | | |
| Example 7 | Reaction | Bi₁₂SiO₂₀ | 8.2 | 0.97 |
| | apparatus 2 | single phase | | |
| Example 8 | Reaction | Bi₁₂SiO₂₀ | 2.5 | 1.00 |
| | apparatus 3 | single phase | | |
| Example 9 | Reaction | Bi₁₂SiO₂₀ | 4.3 | 0.96 |
| | apparatus 4 | single phase | | |

### Example 10

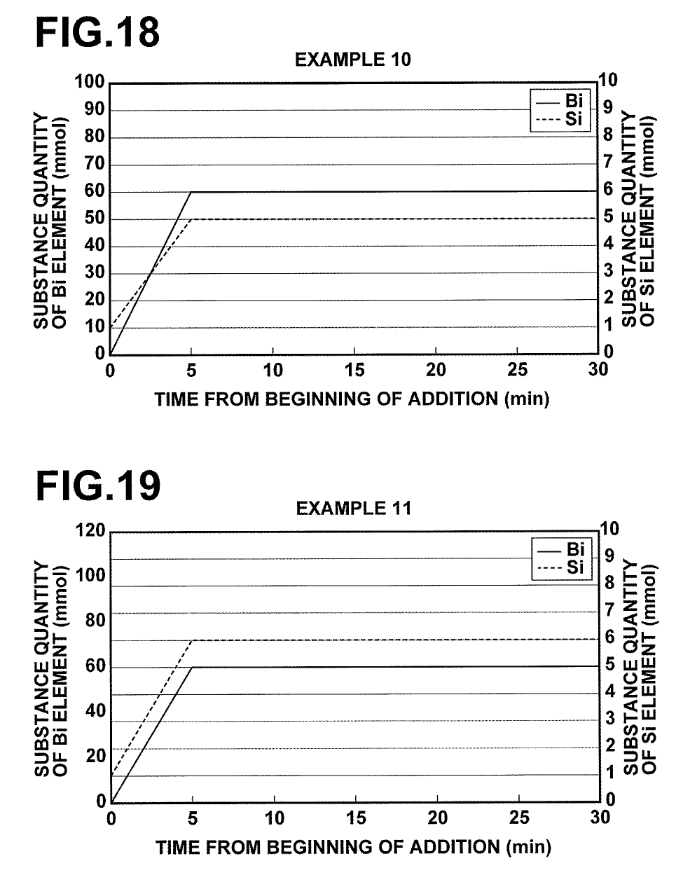

A Bi₁₂SiO₂₀ powder was produced in the same manner as that in Example 1, except that a mother liquor (M-10) having been prepared by adding a potassium silicate solution to 500 ml of the mother liquor (M-1), such that 1 mmol of the Si element might be contained, was used, and except that the Si solution (S-1, 40 ml) was added at a feed rate of 8 ml/min over a period of time of five minutes. FIG. 18 is a graph showing the relationship between the substance quantities of the Bi element and the Si element which were present in the mixed liquid during the addition of the raw material solutions and at the initial stage of the reaction in Example 10.

### Example 11

A Bi₁₂SiO₂₀ powder was produced in the same manner as that in Example 10, except that the Si solution (S-1, 50 ml) was added at a feed rate of 10 ml/min over a period of time of five minutes. FIG. 19 is a graph showing the relationship between the substance quantities of the Bi element and the Si element which were present in the mixed liquid during the addition of the raw material solutions and at the initial stage of the reaction in Example 11.

In each of Examples 10 and 11, the addition to the mother liquor containing the Si element was performed such that the ratio between the substance quantity of the Bi element and the substance quantity of the Si element might be altered. Due to the alteration of the ratio between the substance quantity of the Bi element and the substance quantity of the Si element, the results slightly deviated from the more preferable composition range than in Example 1 were obtained, though the extent of the deviation was practically allowable.

TABLE 4

| | | Mean | |
|---|---|---|---|
| | Crystal | particle | |
| | phase | size (μm) | X/Bi₁₂ |
| Example 1 | Bi₁₂SiO₂₀ | 5.2 | 0.96 |
| | single phase | | |
| Example 10 | Bi₁₂SiO₂₀ | 4.8 | 1.00 |
| | single phase | | |
| Example 11 | Bi₁₂SiO₂₀ | 5.2 | 1.02 |
| | single phase | | |

### Example 12

A Bi₁₂SiO₂₀ powder was produced in the same manner as that in Example 1, except that the temperature of the mother liquor (M-1) prior to the addition of the Bi solution (B-1) and the Si solution (S-1) was set at 25° C., except that the temperature of the mixed liquid, which was obtained after the addition of the Bi solution (B-1) and the Si solution (S-1) at a temperature of 25° C., was raised to 75° C. at a temperature rise rate of 2.5° C./min over a period of time of 20 minutes, and except that the agitation, which was performed after the temperature of the mixed liquid in the reaction chamber 21 had been raised to 75° C., was carried out for 48 hours.

### Example 13

A Bi₁₂SiO₂₀ powder was produced in the same manner as that in Example 1, except that the temperature of the mother liquor (M-1) prior to the addition of the Bi solution (B-1) and the Si solution (S-1) was set at 75° C., except that the temperature of the mixed liquid, which was obtained after the addition of the Bi solution (B-1) and the Si solution (S-1), was raised to 80° C. at a temperature rise rate of 2.5° C./min over a period of time of two minutes, and except that the agitation, which was performed after the temperature of the mixed liquid in the reaction chamber 21 had been raised to 80° C., was carried out for 48 hours.

### Example 14

A Bi₁₂SiO₂₀ powder was produced in the same manner as that in Example 1, except that the temperature of the mixed liquid, which was obtained after the addition of the Bi solution (B-1) and the Si solution (S-1) to the mother liquor (M-1) at a temperature of 50° C., was raised to 65° C. at a temperature rise rate of 2.5° C./min over a period of time of six minutes, and except that the agitation, which was performed after the temperature of the mixed liquid in the reaction chamber 21 had been raised to 65° C., was carried out for 48 hours.

### Example 15

A Bi₁₂SiO₂₀ powder was produced in the same manner as that in Example 1, except that the temperature of the mixed liquid, which was obtained after the addition of the Bi solution (B-1) and the Si solution (S-1) to the mother liquor (M-1) at a temperature of 50° C., was raised to 85° C. at a temperature rise rate of 2.5° C./min over a period of time of 14 minutes.

Table 5 below shows the mean particle size and X/Bi₁₂ in each of Examples 1, 12, 13, 14, and 15. As shown in Table 5, it was found that, in each of Examples 12, 13, 14, and 15, wherein the mixing temperature and the reaction apparatus were altered, the Bi₁₂XO₂₀ powder having been produced by the production process in accordance with the present invention had uniform composition and the mean particle diameter which is not susceptible to agglomeration. In Example 12 wherein the mixing temperature was low, Example 13 wherein the mixing temperature was high, and Example 14 wherein the reaction temperature was low, the required reaction time was as long as 48 hours.

TABLE 5

| | | | | | | Mean | |
|---|---|---|---|---|---|---|---|
| | Mixing | Reaction | Reaction | | Crystal | particle | |
| | temperature | temperature | time | | phase | size (μm) | X/Bi₁₂ |
| Example 1 | 50° C. | 75° C. | 120 | minutes | Bi₁₂SiO₂₀ | 5.2 | 0.96 |
| | | | | | single | | |
| | | | | | phase | | |
| Example | 25° C. | 75° C. | 48 | hours | Bi₁₂SiO₂₀ | 4.8 | 0.97 |
| 12 | | | | | single | | |
| | | | | | phase | | |
| Example | 75° C. | 80° C. | 48 | hours | Bi₁₂SiO₂₀ | 5.4 | 0.98 |
| 13 | | | | | single | | |
| | | | | | phase | | |
| Example | 50° C. | 65° C. | 48 | hours | Bi₁₂SiO₂₀ | 5.2 | 0.96 |
| 14 | | | | | single | | |
| | | | | | phase | | |
| Example | 50° C. | 85° C. | 120 | minutes | Bi₁₂SiO₂₀ | 5.4 | 0.97 |
| 15 | | | | | single | | |
| | | | | | phase | | |

### Example 16

A Bi₁₂SiO₂₀ powder was produced in the same manner as that in Example 3-3 (pH13), except that the Si concentration in the Si solution and the quantity of the Si element added were altered as listed in Table 6 below.

### Example 17

A Bi₁₂SiO₂₀ powder was produced in the same manner as that in Example 3-1 (pH12), except that the Si concentration in the Si solution and the quantity of the Si element added were altered as listed in Table 6 below.

### Example 18

A Bi₁₂SiO₂₀ powder was produced in the same manner as that in Example 1 (pH14), except that the Si concentration in the Si solution and the quantity of the Si element added were altered as listed in Table 6 below.

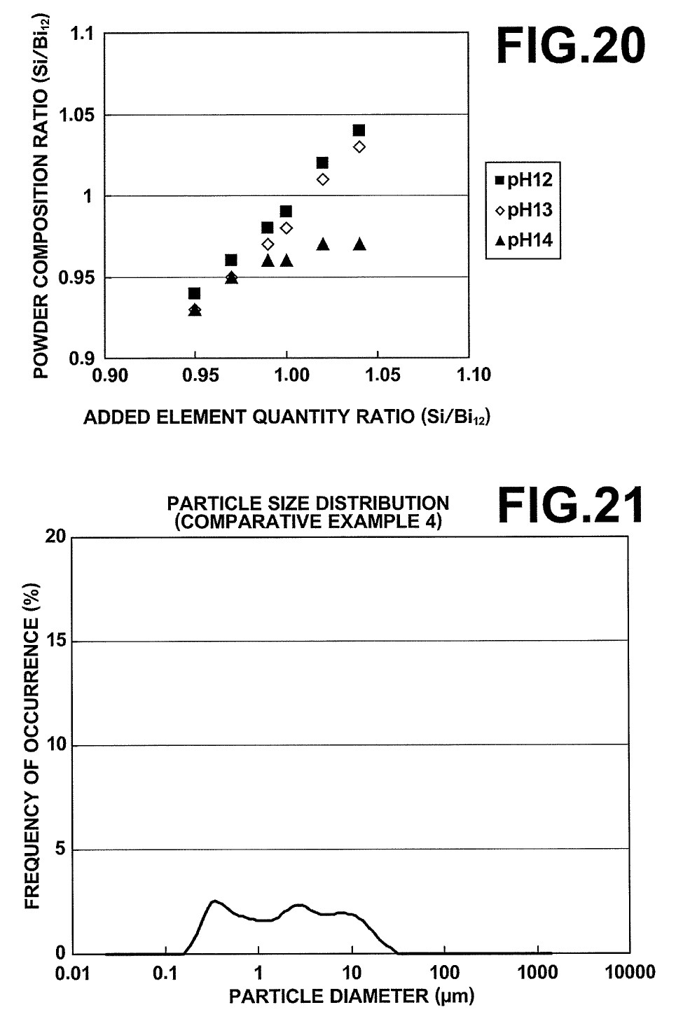

With respect to Examples 16 through 18, Table 6 below lists the Si concentration in the Si solution used, the quantities of the Si element and the Bi element added, the mean particle size measured, and X/Bi₁₂. Also, FIG. 20 shows the relationship between the added element quantity ratio and the powder composition ratio.

TABLE 6

| | | | | | Added | | | |
|---|---|---|---|---|---|---|---|---|
| | | Concentration of | Quantities of | | element | | Mean | |
| | | Si element in Si | elements added | | quantity | | particle | |
| | | solution | (mmol) | | ratio | | size | |
| | Example | (mol/l) | Bi | Si | (Si/Bi₁₂) | Crystal phase | (μm) | X/Bi₁₂ |
| pH13 | 16-1 | 0.095 | 60 | 4.75 | 0.95 | Bi₁₂SiO₂₀ | 5.4 | 0.93 |
| | | | | | | single phase | | |
| | 16-2 | 0.097 | 60 | 4.85 | 0.97 | Bi₁₂SiO₂₀ | 5.3 | 0.95 |
| | | | | | | single phase | | |
| | 16-3 | 0.099 | 60 | 4.95 | 0.99 | Bi₁₂SiO₂₀ | 5.4 | 0.97 |
| | | | | | | single phase | | |
| | 3-3 | 0.1 | 60 | 5.00 | 1.00 | Bi₁₂SiO₂₀ | 5.4 | 0.98 |
| | | | | | | single phase | | |
| | 16-4 | 0.102 | 60 | 5.10 | 1.02 | Bi₁₂SiO₂₀ | 5.2 | 1.01 |
| | | | | | | single phase | | |
| | 16-5 | 0.104 | 60 | 5.20 | 1.04 | Bi₁₂SiO₂₀ | 5.4 | 1.03 |
| | | | | | | single phase | | |
| pH12 | 17-1 | 0.095 | 60 | 4.75 | 0.95 | Bi₁₂SiO₂₀ | 6.0 | 0.94 |
| | | | | | | single phase | | |
| | 17-2 | 0.097 | 60 | 4.85 | 0.97 | Bi₁₂SiO₂₀ | 5.8 | 0.96 |
| | | | | | | single phase | | |
| | 17-3 | 0.099 | 60 | 4.95 | 0.99 | Bi₁₂SiO₂₀ | 5.7 | 0.98 |
| | | | | | | single phase | | |
| | 3-1 | 0.1 | 60 | 5.00 | 1.00 | Bi₁₂SiO₂₀ | 6.2 | 0.96 |
| | | | | | | single phase | | |
| | 17-4 | 0.102 | 60 | 5.10 | 1.02 | Bi₁₂SiO₂₀ | 5.9 | 1.02 |
| | | | | | | single phase | | |
| | 17-5 | 0.104 | 60 | 5.20 | 1.04 | Bi₁₂SiO₂₀ | 5.5 | 1.04 |
| | | | | | | single phase | | |
| pH14 | 18-1 | 0.095 | 60 | 4.75 | 0.95 | Bi₁₂SiO₂₀ | 5.6 | 0.93 |
| | | | | | | single phase | | |
| | 18-2 | 0.097 | 60 | 4.85 | 0.97 | Bi₁₂SiO₂₀ | 5.8 | 0.95 |
| | | | | | | single phase | | |
| | 18-3 | 0.099 | 60 | 4.95 | 0.99 | Bi₁₂SiO₂₀ | 5.4 | 0.96 |
| | | | | | | single phase | | |
| | 1 | 0.1 | 60 | 5.00 | 1.00 | Bi₁₂SiO₂₀ | 5.2 | 0.96 |
| | | | | | | single phase | | |
| | 18-4 | 0.102 | 60 | 5.10 | 1.02 | Bi₁₂SiO₂₀ | 5.3 | 0.97 |
| | | | | | | single phase | | |
| | 18-5 | 0.104 | 60 | 5.20 | 1.04 | Bi₁₂SiO₂₀ | 5.5 | 0.97 |
| | | | | | | single phase | | |

With respect to the Bi₁₂SiO₂₀ powder in Example 3, as illustrated in FIG. 17, it was suggested that the reaction mode at a pH value of at most 13.5 and the reaction mode at a pH value of at least 14 varied from each other. As illustrated in FIG. 20, it was found that, in the cases of pH12 and pH13, the Bi₁₂SiO₂₀ powder composition ratio (Si/Bi₁₂) altered linearly with respect to the added element quantity ratio (Si/Bi₁₂). It was also found that, in the cases of pH14, the Bi₁₂SiO₂₀ powder composition ratio did not alter markedly with respect to the added element quantity ratio. Specifically, it was found that, in the cases of pH12 and pH13, the advantages were obtained in that the particles having the desired composition were obtained by strict control of the loading composition. Also, it was found that, in the cases of pH14, the advantages were obtained in that little fluctuation arose with the composition of the obtained Bi₁₂SiO₂₀ powder, and in that good production reliability was obtained. From the results described above and the results of the X-ray diffraction illustrated in FIG. 17, it was found that, in cases where the pH value of the mixed liquid was adjusted to be equal to at most 13.5, the loading composition and the particle composition altered linearly, and the particles having the desired composition were obtained. Also, it was found that, in cases where the pH value of the mixed liquid was adjusted to be equal to at least 14, the advantages were obtained in that little fluctuation occurred with the composition of the obtained Bi₁₂XO₂₀ powder.

### Comparative Example 1

A Bi₁₂SiO₂₀ powder was produced in the same manner as the technique described in the paper by H. S. Horowitz et al., “SOLUTION SYNTHESIS AND CHARACTERIZATION OF SILLENITE PHASES, Bi₂₄M₂O₄₀ (M=Si, Ge, V, As, P)”, Solid State Ionics, Vols. 32/33, pp. 678-690, 1989. Specifically, 1.213 ml of a potassium silicate solution (supplied by Wako Pure Chemical Industries, Ltd., molar ratio: SiO₂/K₂O=3.9, concentration: 28.0%), a potassium hydroxide solution (supplied by Wako Pure Chemical Industries, Ltd., 8N), and deionized water were mixed together, and 550 ml of a mother liquor was thereby prepared. Thereafter, the Bi solution (B-1, 50 ml) alone was added to the mother liquor at normal temperatures. After the pH value of the resulting mixed liquid was adjusted at 14, the temperature of the mixed liquid was raised to 75° C., and the mixed liquid was allowed to undergo the reaction for two days. During each of the steps of the addition, the temperature raising, and the reaction, agitation was continued by use of a propeller blade made from Teflon®.

After the reaction was finished, the entire reaction system was cooled to the room temperature. The resulting precipitate was collected by filtration and was sufficiently washed with deionized water. The thus obtained solid material was dried at a temperature of 100° C. for 12 hours, and a Bi₁₂SiO₂₀ powder was thus obtained. The identification of the crystal phase of the Bi₁₂SiO₂₀ powder having been obtained was performed by use of the powder X-ray diffraction technique, and it was confirmed that the crystal phase was the Bi₁₂SiO₂₀ single phase. The particle diameters of the particles in the obtained powder were measured by use of the laser diffraction type particle size distribution measuring apparatus, and it was confirmed that the mean particle diameter was equal to 5.6 μm. The analysis of the composition of the obtained powder was made with the inductively coupled plasma atomic emission spectrometry, and it was confirmed that Si/Bi₁₂=0.90.

### Comparative Example 2

A Bi₁₂SiO₂₀ powder was produced in the same manner as the technique described in the paper by H. S. Horowitz et al., “SOLUTION SYNTHESIS AND CHARACTERIZATION OF SILLENITE PHASES, Bi₂₄M₂O₄₀ (M=Si, Ge, V, As, P)”, Solid State Ionics, Vols. 32/33, pp. 678-690, 1989. Specifically, the Bi₁₂SiO₂₀ particles were produced in the same manner as that in Comparative Example 1, except that, after the Bi solution (B-1) had been added to the mother liquor, the pH value of the resulting mixture was adjusted at 13, and except that the reaction time after the temperature raising was performed was set at three hours. The particle diameters of the particles in the obtained powder were measured by use of the laser diffraction type particle size distribution measuring apparatus, and it was confirmed that the mean particle diameter was equal to 5.4 μm. The analysis of the composition of the obtained particles was made with the inductively coupled plasma atomic emission spectrometry, and it was confirmed that Si/Bi₁₂=1.15.

### Comparative Example 3

A Bi₁₂SiO₂₀ powder was produced in the same manner as that described in U.S. Patent Application Publication No. 20060204423. Specifically, 482 g of bismuth nitrate pentahydrate (Bi(NO₃)₃.5H₂O, purity: 99.9%) was dissolved in 800 ml of a 1N aqueous nitric acid solution, and the resulting solution was made up to one liter by the addition of deionized water. In this manner, a Bi solution (B-C3) was prepared. Also, 12.9 g of potassium metasilicate and 325 g of potassium hydroxide were dissolved in water, and the resulting solution was made up to one liter by the addition of water. In this manner, an Si solution (S-C3) was prepared. Further, 7.7 g of potassium metasilicate and 281 g of potassium hydroxide were dissolved in water, and the resulting solution was made up to five liters by the addition of water. In this manner, a mother liquor (M-C3) was prepared.

Thereafter, synthesis of a Bi₁₂SiO₂₀ powder was performed by use of the reaction apparatus 4 provided with the shearing type agitating section 14 as illustrated in FIG. 4. Specifically, the mother liquor (M-3C) was introduced into the reaction chamber 21 having been coated with Teflon®. The mother liquor (M-C3) was heated to a temperature of 90° C., while the shearing type agitating section 14 having been set at a rotation speed of 4,000 revolutions per minute was being operated. At this time, the circumferential speed of the agitating blade was equal to 3.5 m/sec. While the state described above was being kept, the Bi solution (B-C3) accommodated in the solution tank 24a and the Si solution (S-C3) accommodated in the solution tank 24b were added simultaneously with each other through the liquid feeding flow path 25a and the liquid feeding flow path 25b, respectively, at a feed rate of 20 ml per minute to the positions in the vicinity of the shearing type agitating section 14. After the addition was finished, the agitation was continued for a further period of time of 30 minutes at a temperature of 90° C. Thereafter, the reaction mixture was allowed to cool down to normal temperatures, and a pale yellow dispersed reaction product having been formed was collected by filtration. The reaction product having thus been collected by filtration was then washed three times with a 0.1N potassium hydroxide solution and was thereafter washed several times with water. The reaction product was then washed with ethanol. In this manner, a Bi₁₂SiO₂₀ powder was obtained.

The identification of the crystal phase of the Bi₁₂SiO₂₀ powder having been produced was performed by use of the powder X-ray diffraction technique, and it was confirmed that the crystal phase was the Bi₁₂SiO₂₀ single phase. The particle diameters of the particles in the obtained powder were measured by use of the laser diffraction type particle size distribution measuring apparatus, and it was confirmed that the mean particle diameter was equal to 1 μm. The analysis of the composition of the obtained particles was made with the inductively coupled plasma atomic emission spectrometry, and it was confirmed that Si/Bi₁₂=1.00.

The mean particle diameter of the Bi₁₂SiO₂₀ powder obtained in Comparative Example 3 was markedly smaller than the mean particle diameter obtained in each of Examples 12 to 15, in which the temperature raising step was performed. It was presumed that, in Comparative Example 3, wherein the temperature of the mother liquor was as high as 90° C. and wherein the Bi solution and the Si solution were added to the mother liquor, the number of the nuclei formed at the initial stage of the reaction became large, and the particle sizes thus became small.

### Comparative Example 4

### Solid Phase Technique

Firstly, 279.6 g of bismuth oxide (supplied by Kojundo Chemical Laboratory Co., Ltd., purity: 5N) and 6.00 g of an SiO₂ powder (purity: 6N) were dispersed in 200 ml of ethanol. The resulting dispersion was then subjected to mixing and grinding processing by use of an alumina ball mill. After ethanol had been removed by evaporation, the obtained reaction product was put into an alumina crucible and subjected to preliminary firing at a temperature of 800° C. for eight hours. The product having been obtained from the preliminary firing was ground by use of an alumina mortar and was then ground by use of an alumina ball mill. In this manner, a Bi₁₂SiO₂₀ powder was obtained.

The identification of the crystal phase of the Bi₁₂SiO₂₀ powder having been obtained was performed by use of the powder X-ray diffraction technique, and it was confirmed that the crystal phase was the Bi₁₂SiO₂₀ single phase. The particle diameters of the particles in the obtained powder were measured by the observation of an electron microscope image, and it was confirmed that the powder contained particles ranging from particles having particle sizes smaller than 1 μm to fragments having sizes of as large as 10 μm. Also, as illustrated in FIG. 21, with a measurement made by use of the laser diffraction type of particle size distribution measuring apparatus, it was confirmed that the obtained powder had a broad particle diameter distribution ranging from a particle diameter smaller than 1 μm to a particle diameter of as large as 20 μm. The analysis of the composition of the obtained powder was made with the inductively coupled plasma atomic emission spectrometry, and it was confirmed that Si/Bi₁₂=1.00.

### Comparative Example 5

A Bi₁₂SiO₂₀ powder was produced in the same manner as that in Comparative Example 1. The particle diameters of the particles in the obtained powder were measured by use of the laser diffraction type particle size distribution measuring apparatus, and it was confirmed that the mean particle diameter was equal to 5.4 μm. The analysis of the composition of the obtained particles was made with the inductively coupled plasma atomic emission spectrometry, and it was confirmed that Si/Bi₁₂=0.97. From the comparison made between the Si/Bi₁₂ values in Comparative Example 5 and Comparative Example 1, it was found that, with the production technique described in the paper by H. S. Horowitz et al., “SOLUTION SYNTHESIS AND CHARACTERIZATION OF SILLENITE PHASES, Bi₂₄M₂O₄₀ (M=Si, Ge, V, As, P)”, Solid State Ionics, Vols. 32/33, pp. 678-690, 1989, large variation occurred in composition among production lots.

### (Preparation of Detecting Section of Radiation Imaging Panel)

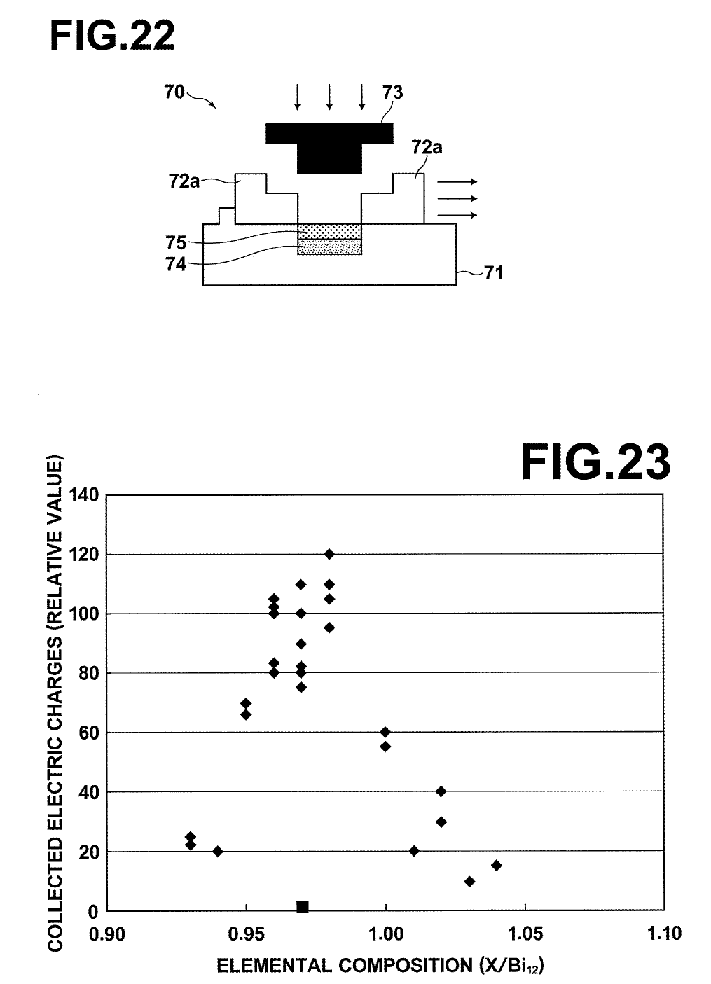

The Bi₁₂XO₂₀ powder having been produced in each of Examples 1 to 11, 13, 16 to 18, and Comparative Examples 1, 2, and 5 was mixed with a water-soluble inorganic binder (GRANDEX FJ294). The obtained mixture was uniform, and a weight ratio of the Bi₁₂XO₂₀ powder to the inorganic binder (in the dry state) was equal to 2:1. An Au/Ti electrode was formed on a quartz glass substrate by use of a vacuum evaporation technique. Also, an adhesive layer (Humiseal 1B12) having a thickness smaller than 0.5 μm was formed on a top surface of the electrode by use of a dip coating technique. Thereafter, by use of a compression apparatus 70 as illustrated in FIG. 22, a quartz glass substrate 74, which had thus been provided with the adhesive layer and the Au/Ti electrode, was set in a mold 71 of a die-pressing apparatus 70. Further, the mixture having been prepared in the manner described above was deposited on the top surface of the adhesive layer, and a die 73 of the compression apparatus 70 was actuated. In this manner, a photo-conductor 75 having a thickness of approximately 150 μm ultimately was prepared. The thickness of the photo-conductor 75 was capable of being adjusted by a spacer 72a located on the compression apparatus 70. The quartz glass substrate, on which the photo-conductor 75 had been deposited, was taken out from the mold 71 and dried at the room temperature. An Au electrode was formed on the top surface of the thus dried photo-conductor 75 by use of the vacuum evaporation technique. In this manner, a detecting section of a radiation imaging panel provided with the photo-conductor sandwiched by the electrodes was completed. (Evaluation method and evaluation results)

With respect to the detecting section of the radiation imaging panel having been prepared by use of the Bi₁₂XO₂₀ powder having been produced in each of Examples 1 to 11, 13, 16 to 18, and Comparative Examples 1, 2, and 5, after a voltage of 500V had been applied across the two electrodes, 10mR X-rays (produced by a tungsten tube, under the condition of a voltage of 80 kV) were irradiated to the detecting section for 0.1 second. A photo-current flowing across the two electrodes at this time was converted into a voltage by use of a current amplifier, and the voltage was measured with a digital oscilloscope. In accordance with the obtained current-time curve, integration was made within the range of the X-ray irradiation time, and the quantity of the collected electric charges per sample area was calculated.

The results as shown in Table 7 below were obtained. FIG. 23 shows the relationship between the elemental composition ratio (X/Bi₁₂) and the collected electric charges. In FIG. 23, the “♦” mark represents the results in Examples 1 to 11, 13, and 16 to 18, and the “▪” mark represents the results in Comparative Example 5.

TABLE 7

| | | | | Collected | |
|---|---|---|---|---|---|
| | | Mean | | electric | |
| | | particle | | charges | |
| | | size | | (relative | |
| | Crystal phase | (μm) | X/Bi₁₂ | value) | Remarks |
| Example 1 | Bi₁₂SiO₂₀ single phase | 5.2 | 0.96 | 100 | |
| Example 2-1 | Bi₁₂SiO₂₀ single phase | 4.8 | 0.97 | 110 | |
| Example 2-2 | Bi₁₂SiO₂₀ single phase | 5.4 | 0.96 | 105 | |
| Example 3-1 | Bi₁₂SiO₂₀ single phase | 6.2 | 0.96 | 100 | |
| Example 3-2 | Bi₁₂SiO₂₀ single phase | 5.8 | 0.97 | 90 | |
| Example 3-3 | Bi₁₂SiO₂₀ single phase | 5.4 | 0.98 | 120 | |
| Example 3-4 | Bi₁₂SiO₂₀ single phase | 5.5 | 0.96 | 80 | |
| Example 3-5 | Bi₁₂SiO₂₀ single phase | 4.2 | 0.98 | 95 | |
| Example 4 | Bi₁₂SiO₂₀ single phase | 5.2 | 0.97 | 80 | |
| Example 5 | Bi₁₂SiO₂₀ single phase | 4.8 | 0.98 | 120 | |
| Example 6 | Bi₁₂GeO₂₀ single phase | 7.5 | 0.97 | 110 | |
| Example 7 | Bi₁₂SiO₂₀ single phase | 8.2 | 0.97 | 100 | |
| Example 8 | Bi₁₂SiO₂₀ single phase | 2.5 | 1.00 | 55 | |
| Example 9 | Bi₁₂SiO₂₀ single phase | 4.3 | 0.96 | 80 | |
| Example 10 | Bi₁₂SiO₂₀ single phase | 4.8 | 1.00 | 60 | |
| Example 11 | Bi₁₂SiO₂₀ single phase | 5.2 | 1.02 | 40 | |
| Example 13 | Bi₁₂SiO₂₀ single phase | 5.4 | 0.98 | 110 | |
| Example 16-1 | Bi₁₂SiO₂₀ single phase | 5.4 | 0.93 | 22 | |
| Example 16-2 | Bi₁₂SiO₂₀ single phase | 5.3 | 0.95 | 66 | |
| Example 16-3 | Bi₁₂SiO₂₀ single phase | 5.4 | 0.97 | 80 | |
| Example 16-4 | Bi₁₂SiO₂₀ single phase | 5.2 | 1.01 | 20 | |
| Example 16-5 | Bi₁₂SiO₂₀ single phase | 5.4 | 1.03 | 10 | |
| Example 17-1 | Bi₁₂SiO₂₀ single phase | 6.0 | 0.94 | 20 | |
| Example 17-2 | Bi₁₂SiO₂₀ single phase | 5.8 | 0.96 | 83 | |
| Example 17-3 | Bi₁₂SiO₂₀ single phase | 5.7 | 0.98 | 105 | |
| Example 17-4 | Bi₁₂SiO₂₀ single phase | 5.9 | 1.02 | 30 | |
| Example 17-5 | Bi₁₂SiO₂₀ single phase | 5.5 | 1.04 | 15 | |
| Example 18-1 | Bi₁₂SiO₂₀ single phase | 5.6 | 0.93 | 25 | |
| Example 18-2 | Bi₁₂SiO₂₀ single phase | 5.8 | 0.95 | 70 | |
| Example 18-3 | Bi₁₂SiO₂₀ single phase | 5.4 | 0.96 | 102 | |
| Example 18-4 | Bi₁₂SiO₂₀ single phase | 5.3 | 0.97 | 75 | |
| Example 18-5 | Bi₁₂SiO₂₀ single phase | 5.5 | 0.97 | 82 | |
| Comparative | Bi₁₂SiO₂₀ single phase | 5.6 | 0.90 | — | Spike-like dark current |
| Example 1 | | | | | occurred, and measurement |
| | | | | | was not possible |
| Comparative | Bi₁₂SiO₂₀ single phase | 5.4 | 1.15 | — | No signal was obtained |
| Example 2 | | | | | |
| Comparative | Bi₁₂SiO₂₀ single phase | 5.4 | 0.97 | 2 | Composition distribution |
| Example 5 | | | | | was broad, and |
| | | | | | characteristics were |
| | | | | | bad. |

As for the radiation imaging panel having been produced by use of the Bi₁₂XO₂₀ powder having been obtained in each of the examples in accordance with the present invention, good film formation was possible since the Bi₁₂XO₂₀ powder had the particle diameters which were not susceptible to agglomeration. Also, as shown in Table 7, by virtue of the uniform composition, good collected electric charge characteristics were obtained. Further, as illustrated in FIG. 23, in cases where the Bi₁₂XO₂₀ powder had the composition satisfying the condition of 0.91≦X/Bi₁₂≦1.09, it was possible to confirm the collected electric charge characteristics. Particularly, it was confirmed that, in cases where the Bi₁₂XO₂₀ powder had the composition satisfying the condition of 0.94≦X/Bi₁₂≦0.99, more appropriate collected electric charge characteristics were obtained.

In the comparative examples, the collected electric charge characteristics were not obtained (Comparative Examples 1 and 2), or were markedly bad (Comparative Example 5). In Table 7 and FIG. 23, the collected electric charge characteristics were represented by the relative value with the collected electric charge characteristics in Example 1 being taken as 100. Therefore, in certain examples, the collected electric charge characteristics were seemingly found to be low. However, as clear from the comparison with the results in comparative examples, the radiation imaging panel having been produced by use of the Bi₁₂XO₂₀ powder having been obtained in each of the examples in accordance with the present invention had the good collected electric charge characteristics.

What is claimed is:

1. A process for producing a Bi₁₂XO₂₀ powder, wherein X represents at least one kind of element selected from the group consisting of Si, Ge, and Ti, the process comprising:
i) a step (A) of preparing a solution containing the Bi element and a solution containing the X element,
ii) a step (B) of adding the solution containing the Bi element and the solution containing the X element to a mother liquor having been previously fed into a reaction chamber, a mixed liquid being thereby prepared, and
iii) a step (C) of raising a temperature of the mixed liquid from the temperature, at which the addition of the solution containing the Bi element and the solution containing the X element to the mother liquor is begun,
the addition of the solution containing the Bi element and the solution containing the X element to the mother liquor in the step (B) being performed such that both of the substance quantity of the Bi element and the substance quantity of the X element in the mixed liquid increase in parallel from the time at which the addition of the solution containing the Bi element and the solution containing the X element to the mother liquor is begun.

2. A process for producing a Bi₁₂XO₂₀ powder as defined in claim 1 wherein, in the step (B), the ratio between the substance quantity of the Bi element and the substance quantity of the X element, which substance quantities are added to the mother liquor, is substantially kept at a predetermined value during the stage from the time, at which the addition of the solution containing the Bi element and the solution containing the X element to the mother liquor is begun, to the time, at which the addition of the solution containing the Bi element and the solution containing the X element to the mother liquor is finished.

3. A process for producing a Bi₁₂XO₂₀ powder as defined in claim 1 wherein, in the step (B), the mixed liquid is prepared by the addition with a double jet technique.

4. A process for producing a Bi₁₂XO₂₀ powder as defined in claim 1 wherein, in the step (B), the preparation of the mixed liquid is performed such that the temperature of the mixed liquid falls within the range of a temperature higher than 25° C. to a temperature lower than 75° C.

5. A process for producing a Bi₁₂XO₂₀ powder as defined in claim 1 wherein, in the step (C), the temperature of the mixed liquid is raised up to a temperature falling within the range of a temperature higher than 65° C. to a temperature lower than 100° C.

6. A process for producing a Bi₁₂XO₂₀ powder as defined in claim 1 wherein a pH value of the mixed liquid is set to be equal to at most 13.5.

7. A process for producing a Bi₁₂XO₂₀ powder as defined in claim 1 wherein a pH value of the mixed liquid is set to be equal to at least 14.

8. A Bi₁₂XO₂₀ powder obtainable by a process for producing a Bi₁₂XO₂₀ powder as defined in claim 1, the Bi₁₂XO₂₀ powder having a mean particle diameter falling within the range of a value larger than 2 μm to a value smaller than 20 μm, the Bi₁₂XO₂₀ powder having a composition satisfying the condition of Formula (1) shown below:
0.91≦X/Bi₁₂≦1.09 (1)
wherein X/Bi₁₂ represents the substance quantity of the X element with respect to 12 mols of the Bi element.

9. A Bi₁₂XO₂₀ powder as defined in claim 8 wherein the Bi₁₂XO₂₀ powder has a composition satisfying the condition of Formula (2) shown below:
0.94≦X/Bi₁₂≦0.99 (2)

10. A radiation photo-conductor, obtainable by use of a Bi₁₂XO₂₀ powder as defined in claim 8.

11. A radiation photo-conductor, containing a Bi₁₂XO₂₀ polycrystal, wherein X represents at least one kind of element selected from the group consisting of Si, Ge, and Ti, with the proviso that the radiation photo-conductor may contain inevitable impurities,
wherein the polycrystal has a composition satisfying the condition of Formula (2):
0.94≦X/Bi₁₂≦0.99 (2)
wherein X/Bi₁₂ represents the substance quantity of the X element with respect to 12 mols of the Bi element.

12. A radiation photo-conductor, containing a binder and a Bi₁₂XO₂₀ powder, the particles of which have been bound with one another by the binder, wherein X represents at least one kind of element selected from the group consisting of Si, Ge, and Ti,
wherein the Bi₁₂XO₂₀ powder has a composition satisfying the condition of Formula (2):
0.94≦X/Bi₁₂≦0.99 (2)
wherein X/Bi₁₂ represents the substance quantity of the X element with respect to 12 mols of the Bi element.

13. A radiation detector, comprising:
i) a radiation photo-conductor as defined in claim 10, and
ii) electrodes for applying an electric field across the radiation photo-conductor.

14. A radiation detector, comprising:
i) a radiation photo-conductor as defined in claim 11, and
ii) electrodes for applying an electric field across the radiation photo-conductor.

15. A radiation detector, comprising:
i) a radiation photo-conductor as defined in claim 12, and
ii) electrodes for applying an electric field across the radiation photo-conductor.

16. A radiation imaging panel, wherein carriers having been generated in a radiation photo-conductor layer by irradiation of radiation to the radiation photo-conductor layer are read out as electric charges by application of an electric field across the radiation photo-conductor layer, the radiation imaging panel comprising:
i) the radiation photo-conductor layer containing a radiation photo-conductor as defined in claim 10,
ii) a pair of electrodes for applying the electric field across the radiation photo-conductor layer, and
iii) electric current detecting means for detecting the carriers having been generated in the radiation photo-conductor layer.

17. A radiation imaging panel, wherein carriers having been generated in a radiation photo-conductor layer by irradiation of radiation to the radiation photo-conductor layer are read out as electric charges by application of an electric field across the radiation photo-conductor layer, the radiation imaging panel comprising:
i) the radiation photo-conductor layer containing a radiation photo-conductor as defined in claim 11,
ii) a pair of electrodes for applying the electric field across the radiation photo-conductor layer, and
iii) electric current detecting means for detecting the carriers having been generated in the radiation photo-conductor layer.

18. A radiation imaging panel, wherein carriers having been generated in a radiation photo-conductor layer by irradiation of radiation to the radiation photo-conductor layer are read out as electric charges by application of an electric field across the radiation photo-conductor layer, the radiation imaging panel comprising:
i) the radiation photo-conductor layer containing a radiation photo-conductor as defined in claim 12,
ii) a pair of electrodes for applying the electric field across the radiation photo-conductor layer, and
iii) electric current detecting means for detecting the carriers having been generated in the radiation photo-conductor layer.

19. A radiation imaging panel, wherein carriers having been generated in a radiation photo-conductor layer by irradiation of radiation to the radiation photo-conductor layer are accumulated as electric charges, wherein an electrostatic latent image is thereby formed, and wherein the electric charges are read out by irradiation of light, the radiation imaging panel comprising:
i) a first electrode for applying an electric field across the radiation photo-conductor layer,
ii) the radiation photo-conductor layer containing a radiation photo-conductor as defined in claim 10,
iii) a charge transporting layer for accumulating the carriers as the electric charges,
iv) a reading photo-conductor layer for taking out the electric charges, which have been accumulated at the charge transporting layer, by the irradiation of the light,
v) a second electrode for applying the electric field across the radiation photo-conductor layer, and
vi) electric current detecting means for detecting the electric charges having been taken out into the reading photo-conductor layer,
the first electrode, the radiation photo-conductor layer, the charge transporting layer, the reading photo-conductor layer, the second electrode, and the electric current detecting means being located successively.

20. A radiation imaging panel, wherein carriers having been generated in a radiation photo-conductor layer by irradiation of radiation to the radiation photo-conductor layer are accumulated as electric charges, wherein an electrostatic latent image is thereby formed, and wherein the electric charges are read out by irradiation of light, the radiation imaging panel comprising:
i) a first electrode for applying an electric field across the radiation photo-conductor layer,
ii) the radiation photo-conductor layer containing a radiation photo-conductor as defined in claim 11,
iii) a charge transporting layer for accumulating the carriers as the electric charges,
iv) a reading photo-conductor layer for taking out the electric charges, which have been accumulated at the charge transporting layer, by the irradiation of the light,
v) a second electrode for applying the electric field across the radiation photo-conductor layer, and
vi) electric current detecting means for detecting the electric charges having been taken out into the reading photo-conductor layer,
the first electrode, the radiation photo-conductor layer, the charge transporting layer, the reading photo-conductor layer, the second electrode, and the electric current detecting means being located successively.

21. A radiation imaging panel, wherein carriers having been generated in a radiation photo-conductor layer by irradiation of radiation to the radiation photo-conductor layer are accumulated as electric charges, wherein an electrostatic latent image is thereby formed, and wherein the electric charges are read out by irradiation of light, the radiation imaging panel comprising:
i) a first electrode for applying an electric field across the radiation photo-conductor layer,
ii) the radiation photo-conductor layer containing a radiation photo-conductor as defined in claim 12,
iii) a charge transporting layer for accumulating the carriers as the electric charges,
iv) a reading photo-conductor layer for taking out the electric charges, which have been accumulated at the charge transporting layer, by the irradiation of the light,
v) a second electrode for applying the electric field across the radiation photo-conductor layer, and
vi) electric current detecting means for detecting the electric charges having been taken out into the reading photo-conductor layer,
the first electrode, the radiation photo-conductor layer, the charge transporting layer, the reading photo-conductor layer, the second electrode, and the electric current detecting means being located successively.
